(19) United States
(12) Patent Application Publication
(10) Pub. No.: US 2017/0031514 A1
(43) Pub. Date: Feb. 2, 2017

(54) DISPLAY DEVICE AND ELECTRONIC EQUIPMENT

(71) Applicant: SHARP KABUSHIKI KAISHA, Sakai City, Osaka (JP)

(72) Inventors: Tomohiro KIMURA, Osaka (JP); Yasuhiro SUGITA, Osaka (JP)

(73) Assignee: Sharp Kabushiki Kaisha, Osaka (JP)

(21) Appl. No.: 15/302,639

(22) PCT Filed: Feb. 25, 2015
(86) PCT No.: PCT/JP2015/055429

§ 371 Date: Oct. 7, 2016

(30) Foreign Application Priority Data
Apr. 14, 2014 (JP) 2014-083201

(51) Int. Cl. G06F 3/041; G02F 1/1333; G06F 3/044

(52) U.S. Cl. CPC G06F 3/0416; G06F 3/044; G06F 3/0412; G02F 1/13338; G06F 2203/04101

(57) ABSTRACT

A display device includes a display panel and a touch panel. The touch panel includes a first region that overlaps a display area, and a second region outside of the first region. At least one of the following differs between the first region and the second region: a material of first electrodes and second electrodes; an interval between the first electrodes or between the second electrodes; a shape of the first electrodes or the second electrodes; a controller to which the first electrodes and the second electrodes are connected; and a location at which lead-out wiring lines connected to the first electrodes or second electrodes are disposed.

### TECHNICAL FIELD

The present disclosure relates to a display device having a touch panel equipped with technology that detects the contact or proximity of an object.

### BACKGROUND ART

Display devices such as smart phones and tablets have a touch panel. Patent Document 1, for example, discloses technology that detects the change in electric field between a pair of electrodes on a panel when a finger is close to the electrodes, thereby detecting the location of the finger. Touch panels are commonly provided overlapping a display panel that has a display area for displaying images.

### RELATED ART DOCUMENTS

### Patent Documents

Patent Document 1: U.S. Pat. No. 6,452,514 Specification

### SUMMARY OF THE INVENTION

### Problems to be Solved by the Invention

The inventors of the present invention are developing a touch panel that can detect an object not only in the area overlapping the display area of the touch panel, but also in areas outside the display area, such as in the edge area. Conventionally, there has been no configuration that has the detection characteristics, such as precision and sensitivity, suitable for both the area overlapping the display area and the areas outside the display area. Thus, the present application discloses a technology for realizing detection characteristics suitable for both the area overlapping the display area of the touch panel and the areas outside the display area.

### Means for Solving the Problems

A display device of the present disclosure includes a display panel including a display area that displays an image; and a touch panel including a plurality of first electrodes and a plurality of second electrodes overlapping the display panel, and a controller that detects contact or approach of an object by detecting capacitances among the first electrodes and second electrodes. The touch panel includes a first region overlapping the display area, and a second region outside the first region. At least one of the following differs between the first region and the second region: a material of the first electrodes and the second electrodes; an interval between the first electrodes or between the second electrodes; a shape of the first electrodes or the second electrodes; a controller to which the first electrodes and the second electrodes are connected; and a location at which lead-out wiring lines connected to the first electrodes or the second electrodes are disposed.

### Effects of the Invention

The disclosure of the present application makes it possible to realize a display device that has detection characteristics suitable for detecting objects both in the area overlapping the display area of the touch panel and in the areas outside the display area.

### BRIEF DESCRIPTION OF THE DRAWINGS

FIG. 1 is a cross-sectional view that shows one example of a configuration of a display device of Embodiment 1.

FIG. 2 is a plan view that shows one example of a configuration of the touch panel 2 of FIG. 1 as seen from a direction along the arrow II.

FIG. 3 shows one example of a waveform of a driving signal applied to the second electrodes 5 and 7 of the touch panel 2 of FIG. 2.

FIG. 4 shows another example of a waveform of a driving signal applied to the second electrodes 5 and 7 of the touch panel 2 of FIG. 2.

FIG. 5 shows an example of the process flow of a display device 10, which includes the touch panel 2.

FIG. 6 is a plan view that shows one example of a configuration of a display device 10 of Embodiment 2.

FIG. 7 shows one example of a waveform of a driving signal applied to the second electrodes 5 and 7 of the touch panel 2 of FIG. 6.

FIG. 8 is a plan view that shows one example of a configuration of a display device 10 of Embodiment 3.

FIG. 9 shows a modification example of first electrodes and second electrodes, the respective intervals of which differ from region R1 to region R2.

FIG. 10 shows one example of a waveform of a driving signal applied to the second electrodes 5 and 7 of the touch panel 2 of FIG. 8.

FIG. 11 shows one example of a configuration of a display device 10 of Embodiment 4. FIG. 12 shows one example of a waveform of a driving signal applied to the second electrodes 5 and 7 of the touch panel 2 of FIG. 11.

FIG. 13 shows an example of the process flow of the entire display device 10, which includes the touch panel 2 shown in FIG. 11.

FIG. 14 shows one example of a layer configuration of a display device of Embodiment 5.

FIG. 15 is a cross-sectional view of the display device 10 of FIG. 14.

FIG. 16 is a view of an electrode configuration example of a first layer 2-1 of the touch panel 2 shown in FIGS. 14 and 15.

FIG. 17 is a view of an electrode configuration example of a second layer 2-2 of the touch panel 2 shown in FIGS. 14 and 15.

FIG. 18 shows one example of a configuration of a display device 10 of Embodiment 6.

FIG. 19 is a functional block diagram showing a configuration example of the display device 10 of Embodiment 6.

FIG. 20 shows one example of an image displayed on a first display area AA1 and a second display area AA2.

FIG. 21 shows an example of the placement of region R2 above and below region R1.

FIG. 22 shows one example of a waveform of a driving signal applied to the second electrodes 5 and 7 of the touch panel 2 of FIG. 21.

FIG. 23 shows an example of the placement of region R2 to the left and right and above and below region R1.

FIG. 24 shows one example of a waveform of a driving signal applied to the second electrodes 5 and 7 of the touch panel 2 of FIG. 23.

FIG. 25 is a cross-sectional view that shows one example of a configuration for detecting objects on the edge of a transparent cover of a touch panel.

### DETAILED DESCRIPTION OF EMBODIMENTS

A display device in one embodiment of the present invention includes a display area that displays an image; and a touch panel including a plurality of first electrodes and a plurality of second electrodes overlapping the display panel, and a controller that detects contact or approach of an object by detecting capacitances among the first electrodes and second electrodes. The touch panel includes a first region overlapping the display area, and a second region outside the first region. At least one of the following differs between the first region and the second region: a material of the first electrodes and the second electrodes; an interval between the first electrodes or between the second electrodes; a shape of the first electrodes or the second electrodes; a controller to which the first electrodes and the second electrodes are connected; and a location at which lead-out wiring lines connected to the first electrodes or the second electrodes are disposed.

The above-mentioned configuration makes it possible to differ the configuration of the electrodes used for object detection between the first region and second region. Thus, the detection characteristics of the first region differ from the detection characteristics of the second region. This allows for the realization of detection characteristics suited for detecting objects in both the first region overlapping the display area of the touch panel and the second region that is outside the first region.

In the above-mentioned configuration, the interval between the first electrodes or between the second electrodes in the second region can be smaller than the interval between the first electrodes or between the second electrodes in the first region. This allows for the detection precision of the second region to be made greater than the first region.

In the above-mentioned configuration, the touch panel can include a transparent cover covering the first electrodes and the second electrodes, and the touch panel can detect contact or approach of the object at an edge of the transparent cover via the first electrodes and the second electrodes in the second region. This makes it possible to differ the detection precision for objects in the display area from the detection precision for objects on the edge of the transparent cover outside the display area. Thus, it is possible to realize detection characteristics suited for detecting objects in both the portion of the transparent cover overlapping the display area and the edge of the transparent cover.

In the above-mentioned configuration, the first electrodes and the second electrodes in the first region can be transparent conductors, and the first electrodes and the second electrodes in the second region can be metal conductors. This allows for the resistance of the first electrodes and second electrodes in the second region to be made less than the resistance of the first electrodes and second electrodes in the first region. This makes it possible to further improve detection performance in the second region.

In the above-mentioned configuration, the first electrodes and the second electrodes in the first region can be formed in a layer different from a layer in which the first electrodes and the second electrodes in the second region are formed. This makes it possible to increase the design freedom of the first electrodes and second electrodes in the first region and second region, respectively.

In the above-mentioned configuration, a plane on which the first electrodes and the second electrodes in the first region are provided and a plane on which the first electrodes and the second electrodes in the second region are provided can both be parallel to a display surface of the display panel. This forms the first electrodes and second electrodes in the first region and the first electrodes and second electrodes in the second region on the same plane or parallel planes, thereby preventing the electrode forming process from becoming too complex. As a result, it is easy to differ detection performance between the first region and second region.

The display panel may include a first display area corresponding to the first region of the touch panel, and a second display area corresponding to the second region of the touch panel. In such a case, the display device can further include a first image generator that generates an image to be displayed in the first display area in accordance with a location of an object detected in the first region of the touch panel, and a first image generator that generates an image to be displayed in the second display area in accordance with a location of an object detected in the second region of the touch panel. This makes it possible to control the display of the second display area independently of the display of the first display area.

In the above-mentioned configuration, at least a portion of the first electrodes or the second electrodes in the first region can be connected to at least a portion of the first electrodes or the second electrodes in the second region. This makes it possible for at least a portion of the electrodes for detecting objects to be shared between the first region and the second region. This allows for a reduction in the components of the touch panel. Furthermore, it becomes easier to detect a series of objects straddling the first region and the second region.

Various types of electronic devices including the above-mentioned display device are included in the embodiments of the present invention.

Embodiments of the present invention will be described in detail below with reference to the drawings. Portions in the drawings that are the same or similar are assigned the same reference characters and descriptions thereof will not be repeated. For ease of description, drawings referred to below show simplified or schematic configurations, and some of the components are omitted. Components shown in the drawings are not necessarily to scale.

### Embodiment 1

### Configuration Example of Touch Panel

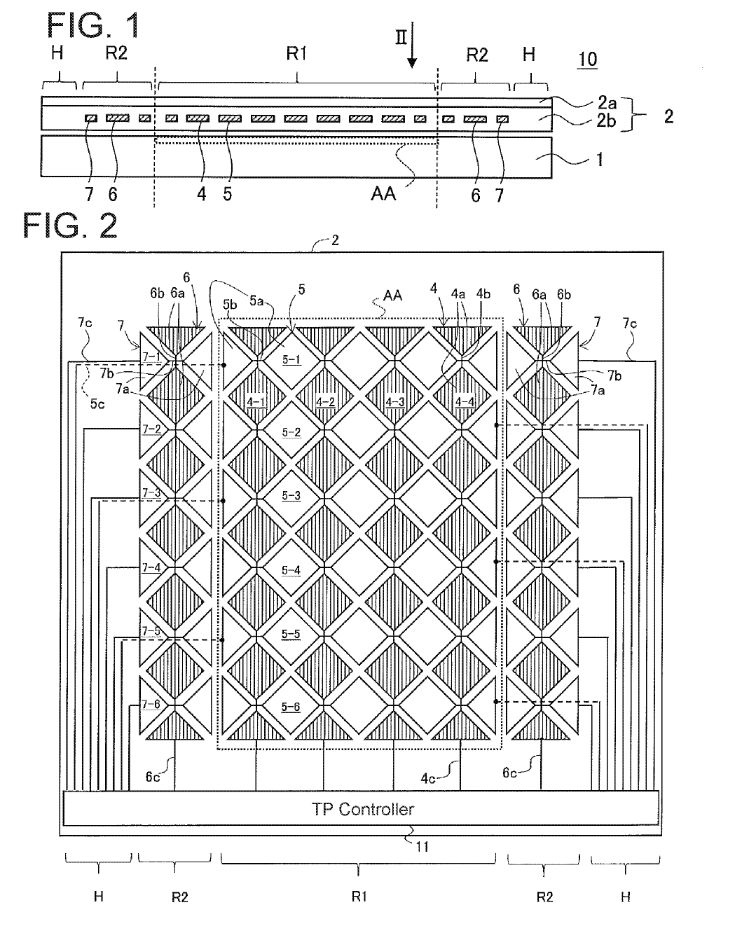

FIG. 1 is a cross-sectional view that shows one example of a configuration of a display device 10 of Embodiment 1. FIG. 2 is a plan view that shows one example of a configuration of the touch panel 2 of FIG. 1 as seen from a direction along the arrow II.

In the example shown in FIG. 1, the display device 10 includes a display panel 1, and a touch panel 2 overlapping the display panel 1. The display panel 1 has a display area AA where images are displayed. The display area AA is an area where pixels for display images are arranged. The form of the display panel 1 has no specific limitations, but can be a liquid crystal panel, for example. The liquid crystal panel includes an active matrix substrate, opposite substrate, and a liquid crystal layer provided between the active matrix substrate and the opposite substrate.

The touch panel 2 is provided overlapping the touch panel 1 so as to cover the display area AA. The light from the pixels of the display area AA passes through the touch panel 2 and is emitted from the surface of the touch panel 2. In the example shown in FIG. 1, there is an air interval between the display panel 1 and the touch panel 2.

The touch panel 2 includes a transparent substrate 2b, first electrodes 4 and 6, second electrodes 5 and 7, and a transparent cover 2a. The first electrodes 4 and 6 & second electrodes 5 and 7 are provided on the transparent substrate 2b. The transparent cover 2a is disposed so as to cover the first electrodes 4 and 6 & second electrodes 5 and 7. The touch panel 2 detects the capacitance between these first electrodes and second electrodes in order to detect the contact or approach of an object such as a finger or pen.

The material of the first electrodes 4 and second electrodes 5 in region R1 (one example of a first region) overlapping the display area AA of the touch panel 2 differs from the material of the first electrodes 6 and second electrodes 7 in region R2 (one example of a second region) outside the region R1. For example, the material of the first electrodes 4 and 6 & second electrodes 5 and 7 can be chosen such that the electrical resistance of the first electrodes 6 and second electrodes 7 in region R2 is lower than the electrical resistance of the first electrodes 4 and second electrodes 5 in region R1. In this manner, making the electrical properties of the first electrodes 4 and second electrodes 5 in region R1 differ from the first electrodes 6 and second electrodes 7 in region R2 allows for the detection characteristics of objects to be different in region R1 and region R2.

In the example shown in FIG. 2, the touch panel 2 has, in region R1 overlapping the display area AA, a plurality of first electrodes 4 (4-1 to 4-4) extending in a first direction (in this example, the vertical direction of the drawing) and a plurality of second electrodes 5 (5-1 to 5-6) extending in a second direction (in this example, the horizontal direction of the drawing) that differs from the first direction. The first electrodes 4 and second electrodes 5 are not electrically connected and are insulated from one another.

Each of the first electrodes 4 is constituted by a first electrode pad 4a, a plurality of which are arranged in the first direction, and a first connection line 4b that connects adjacent first electrode pads 4 together. Each of the second electrodes 5 is also constituted by a second electrode pad 5a, a plurality of which are arranged in a direction perpendicular to the first direction, and a second connection line 5b that connects adjacent second electrode pads 5a together. The first electrode pads 4a and the second electrode pads 5a are arranged so as to be adjacent to one another.

In region R2 to the left and right of region R1 there are also first electrodes 6 extending in the first direction and a plurality of second electrodes 7 (7-1 to 7-2) extending in the second direction differing from the first direction. Each of the first electrodes 6 in region R2 is constituted by a first electrode pad 6a, a plurality of which are arranged in the first direction, and a first connection line 6b that connects adjacent first electrode pads 6 together. Each of the second electrodes 7 is also constituted by a second electrode pad 7a, a plurality of which are arranged in the second direction, and a second connection line 7b that connects adjacent second electrode pads 7a together. The first electrode pads 6a and the second electrode pads 7a are arranged so as to be adjacent to one another. The first electrodes 6 and second electrodes 7 are not electrically connected and are insulated from one another. Furthermore, second electrodes 5 of region R1 and second electrodes 7 of region R2 are not connected and are insulated from one another. For example, the portion where the first electrodes 6 and second electrodes 7 overlap in a plan view, or namely, the intersections of the first electrodes 6 and the second electrodes 7 have an insulating layer between the first electrodes 6 and second electrodes 7.

In the example shown in FIG. 2, the plurality of square electrode pads 4a, 5a, 6a, and 7a are arrayed in a matrix having rows and columns. The plurality of first electrode pads 4a and 6a arranged in the vertical direction of the display screen form columns. The plurality of second electrode pads 5a and 7a arranged in the horizontal direction of the display screen form rows. The respective columns of the first electrodes 4 and 6 are connected to a TP controller 11 (touch panel controller) via first lead-out wiring lines 4c and 6c. The respective rows of the second electrodes 5 and 7 are connected to the TP controller 11 via second lead-out wiring lines 5c and 7c. Furthermore, the first lead-out wiring lines 4c and 6c & the second lead-out wiring lines 5c and 7c are arranged in a wiring area H outside region R1 and region R2.

The TP controller 11 controls the voltage signals of the first electrodes 4 and 6 & second electrodes 5 and 7 so as to detect changes in capacitance between adjacent first electrodes 4 and 6 & second electrodes 5 and 7. The TP controller 11 can identify, in accordance with the detected changes in capacitance, the location of an object that is approaching or contacting the touch panel 2. The TP controller 11 is one example of a control unit that detects the contacting or approaching of an object based on capacitance between the first electrodes and second electrodes. The TP controller can be a semiconductor chip (not shown) provided on the touch panel 2 or on an FPC (not shown) connected to the touch panel 2, for example.

The first electrodes 4 and second electrodes 5 of region R1 can be transparent conductors such as ITO, for example. The first electrodes 6 and second electrodes 7 of region R2 can be a metal having lower resistance than the transparent conductors, such as Al, Co, or Mo. Using low-resistance wiring lines for the first electrodes 6 and second electrodes 7 of region R2 in this manner makes it possible to reduce the noise component in signals passing through the electrodes in region R2. Therefore, it is possible to have high performance detection of objects in region R2. It is possible to have more precise or sensitive detection in region R2 than region R1, for example. Alternatively, it is possible to enable hover detection in region R2. Hover detection detects the position of an object that is close to the touch panel 2 but not making contact.

The configuration of the first electrodes 4 and 6 & second electrodes 5 and 7 shown in FIGS. 1 and 2 are examples, and the configuration of the first electrodes and second electrodes are not limited to the above examples. For example, in the configuration described above, the interval between the first electrodes 4 or second electrodes 5 in region R1 can be different from the interval between the first electrodes 6 or second electrodes 7 in region R2. Furthermore, the shape of the first electrodes 4 or the second electrodes 5 in region R1 may differ from the shape of the first electrodes 6 or second electrodes 7 in region R2. In addition, the lead-out direction of the lead-out wiring lines 5c in region R1 may differ from the lead-out direction of the lead-out wiring lines 7c in region R2. Moreover, the TP controller 11 to which the first electrodes 4 and second electrodes 5 in region R1 are connected may differ from the TP controller 11 to which the first electrodes 6 and second electrodes 7 in region R2 are connected. The number of first electrodes and second electrodes is also not limited to that shown in FIGS. 1 and 2.

(Operation Example)

The touch panel 2 shown in FIG. 2 is a capacitive touch panel. For example, when an object such as a pen or finger approaches or contacts the adjacent first electrode pads 4a and second electrode pads 5a, the capacitance between the first electrode pads 4a and second electrode pads 5a changes. Detecting this change in capacitance makes it possible to detect the approach or contact of the object. The touch panel 2 detects the capacitance between the first electrodes 4 and second electrodes 5 in region R1, thereby detecting the contact or approach of an object in region R1. The touch panel 2 also detects the capacitance between the first electrodes 6 and second electrodes 7 in region R2, thereby detecting the contact or approach of an object in region R2.

In region R1, either the first electrodes 4 or second electrodes 5 can be driving electrodes to which a driving voltage is applied, and the other electrodes can be detection electrodes for detecting capacitance values, for example. In a similar manner, in region R2, either the first electrodes 6 or second electrodes 7 can be driving electrodes, and the other electrodes can be detection electrodes. The driving electrodes may be referred to as driving lines or transmission lines. The detection electrodes may be referred to as sensor lines or reception lines.

The TP controller 11 sends driving signals to the second electrodes 5 and 7 and receives response signals from the first electrodes 4 and 6, thereby making it possible to obtain the capacitance values between the first electrodes 4 and 6 & second electrodes 5 and 7. It is possible to obtain the values corresponding to the respective intersections (nodes) of the first electrodes 4 and 6 & second electrodes 5 and 7 as these capacitance values, for example.

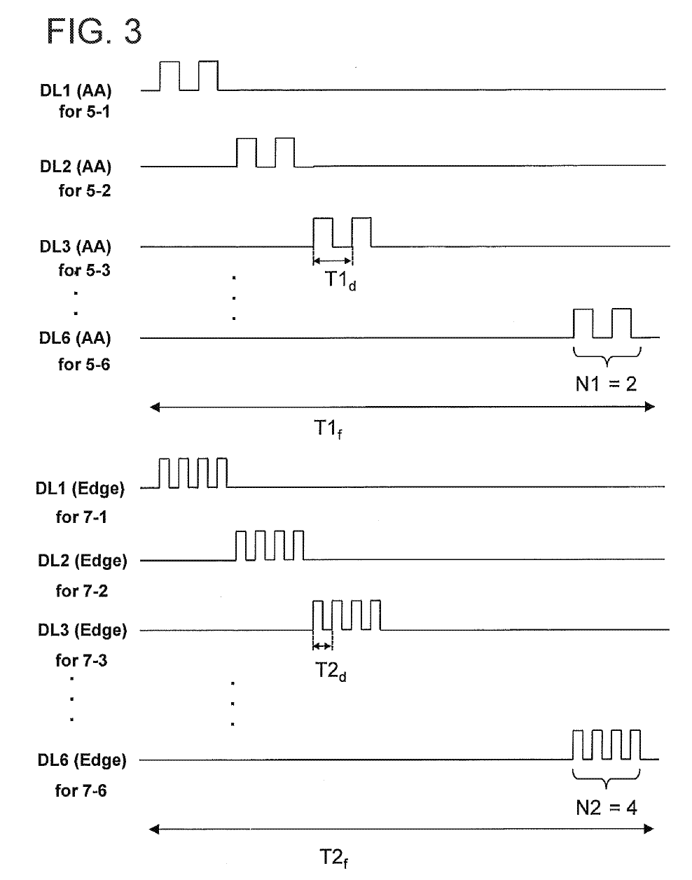

FIG. 3 shows one example of waveforms of driving signals applied to the second electrodes 5 and 7 in the touch panel 2 of FIG. 2. In FIG. 3, DL1 (AA), DL2 (AA), DL3 (AA), . . . , DL6 (AA) at the top represent waveforms of the driving signals sent to the respective second electrodes 5-1, 5-2, 5-3, . . . , 5-6 in region R1 overlapping the display area AA. DL1 (Edge), DL2 (Edge), DL3 (Edge), . . . , DL6 (Edge) at the bottom represent waveforms of the driving signals sent to the respective second electrodes 7-1, 7-2, 7-3, . . . , 7-6 in region R2.

In the example shown in FIG. 3, in region R1, at period T1d pulses are sequentially applied at a pre-determined number of times or N1 times each (N1=2 in the present example) to the second electrodes 5-1, 5-2, 5-3, . . . , 5-6, which are the driving electrodes. This number of times N1 can be referred to as the integral number of times, for example. In synchronization with the pulse of the second electrode 5-1, the TP controller 11 detects the voltage signals of the respective plurality of first electrodes 4-1 to 4-4 intersecting the second electrode 5-1. When a single pulse is applied in DL1 (AA), the resulting charge corresponding to the capacitance between the second electrodes 5-1 and first electrodes 4-1 is transmitted to the storage capacitor of the TP controller 11 and held there, for example. This charge transmission and holding operation is repeated N1 times (N1=2 in the present example). Thereafter, the TP controller 11 measures the voltage from the charge stored in the storage capacitor by the N1 amount of pulses. The measurement value can be used to determine the presence/absence of an object or the capacitance value at the position corresponding to the intersection between the second electrode 5-1 and first electrode 4-1. In this case, the integral amount N1 is the number of pulses applied to the driving electrodes during a single measurement of one of the driving electrodes. In other words, the integral amount is the number of driving signal pulses applied to the driving electrodes (second electrodes 5 and 7) during a single measurement.

In region R2, at period T2d pulses are sequentially applied at a pre-determined number of times or N2 times each (N2=4 in the present example) to the second electrodes 7-1, 7-2, 7-3, . . . , 7-6, which are the driving electrodes. In other words, the number of driving signal pulses or integral amount N2 applied to the driving electrodes in region R2 differs from the integral amount N1 in region R1. The period T2d of the driving signal pulses in region R2 also differs from the period T1d of the driving signal pulses in region R1.

In the present example, the time required to drive the plurality of second electrodes 5-1 to 5-6 in region R1, or namely the operating time T1f equivalent to one frame, is the same as the time required to drive the plurality of second electrodes 7-1 to 7-6 in region R2, or namely the operating time T2f equivalent to one frame. In this example, the operating time can also be called the prescribed sensing time required to scan region R1 or region R2.

In the present embodiment, the resistance of the first electrodes 6 and second electrodes 7 in region R2 is lower than the resistance of the first electrodes 4 and second electrodes 5 in region R1. Furthermore, there are fewer intersections of the first electrodes 6 and second electrodes 7 in region R2 than there are intersections of the first electrodes 4 and second electrodes 5 in region R1. Thus, the intersection capacitance of region R2 less than the intersection capacitance of region R1. As a result, the total load capacitance of region R2 is less than the total load capacitance of region R1. This facilitates making the integral amount N2 of region R2 greater than the integral amount N1 of region R1. By multiplying the integral amount n times (where n is a natural number), it is possible to multiply noise by INN, for example. This can improve the S/N ratio, the sensitivity of the touch panel, and hover detection performance.

In this manner, in region R2, it is possible to make the number of driving signal pulses applied to the respective second electrodes 7 different from the number of driving signal pulses applied to the respective second electrodes 5 in region R1. This allows for suitable driving that is in line with the S/N ratio, sensitivity, hover detection performance and the like as required in region R1 and region R2.

(Driving Modification Example)

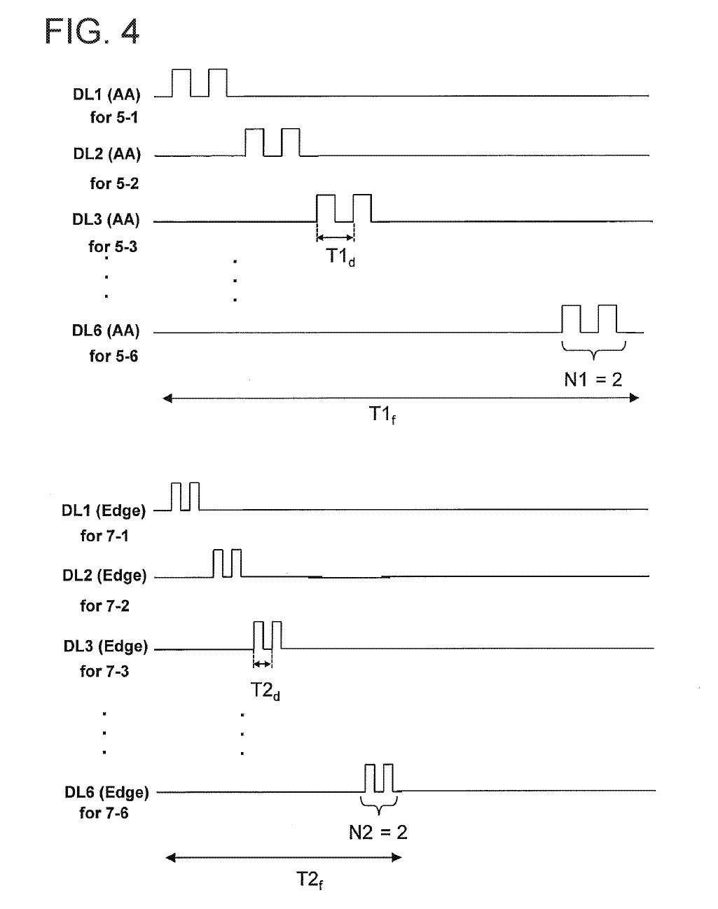

FIG. 4 shows another example of waveforms of driving signals applied to the second electrodes 5 and 7 in the touch panel 2 of FIG. 2. In the example shown in FIG. 4, period T1d of the driving signal pulse applied to the respective second electrodes 5 in region R1 is shorter than the period T2d of the driving signal pulse applied to the respective electrodes 7 in region R2. The amount N1 of driving signal pulses in region R1, or namely the integral amount N1, is the same as the integral amount N2 of driving signals in region R2 (in this present example, N1=N2=2). This causes the operating time T2f equivalent to one frame in region R2 to be shorter than the operating time T1f equivalent to one frame in region R1.

In the configuration shown in FIG. 2, as described above, the total load capacitance of region R2 is less than the total load capacitance of region R1. Thus, it is easy to reduce the operating time T2f of region R2. For example, speeding up the operating time of region R2 by 1/n times (where n is a natural number) makes it possible to speed up the report rate of the touch panel in region R2 by approximately n times. Therefore, in region R2, it is possible to achieve high-speed operation of the touch panel, a high degree of finger motion tracking, higher precision, and the like, for example.

In the example shown in FIG. 3 described above, the integral amounts and periods differed from region R1 to region R2. The operating time equivalent to one frame is the same in region R1 and region R2. In contrast, in the example shown in FIG. 4, the number of pulses is the same in region R1 and region R2, but the period of the pulses is different. Therefore, the operating time required for the scanning of the driving electrodes equivalent to one frame differs from region R1 to region R2. In all of these examples, the driving signals applied to the driving electrodes of region R2 differ from the driving signals applied to the driving electrodes of region R1. This allows for suitable driving that is in line with detection characteristics required in region R1 and region R2.

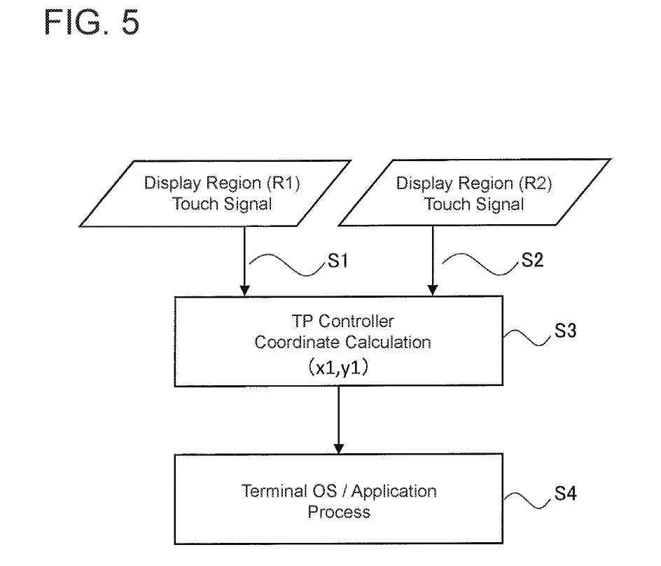

FIG. 5 shows an example of the total process flow of the display device 10, which includes the touch panel 2. In the example shown in FIG. 5, the touch signal for detecting the contact or approaching of an object to the display area AA is transmitted to the TP controller 11 via the first electrodes 4 in region R1 of the touch panel 2 (S1). Furthermore, the touch signal for detecting the contact or approaching of an object to the edge area outside the display area AA is transmitted to the TP controller 11 via the first electrodes 6 in region R2 (S2).

The TP controller 11 makes it possible to differentiate and independently process the touch signal of the display area AA and the touch signal of the edge area, For example. In other words, the TP controller 11 can calculate touch input data (e.g., coordinates) of the display area AA based on a touch signal from region R1, and then calculate touch input data of the edge area based on a touch signal from region R2 (S3). In such a case, it is possible to make the precision of the touch input data of region R2 higher than region R2 because the resistance of the first electrodes 6 and second electrodes 7 of region R2 is low. Alternatively, hover height or the like in region R2 can also be calculated by the TP controller 11.

The touch input data calculated by the TP controller 11 is output to a computer in the display device 10, for example. The touch input data output from the TP controller 11 is used in processes by a terminal OS or application run by the computer in the display device 10 (S4). Alternatively, the touch input data may be data including coordinates showing the position of the contact finger, for example. The touch input data may also be data showing content of the operation (e.g., touch, release, etc.) and location of the operation. The touch input data may also be data showing detection values for individual coordinates (e.g., a capacitance map or the like). The touch input data output from the TP controller 11 is also used by the computer in the display device 10 to calculate hover height and the like.

### Embodiment 2

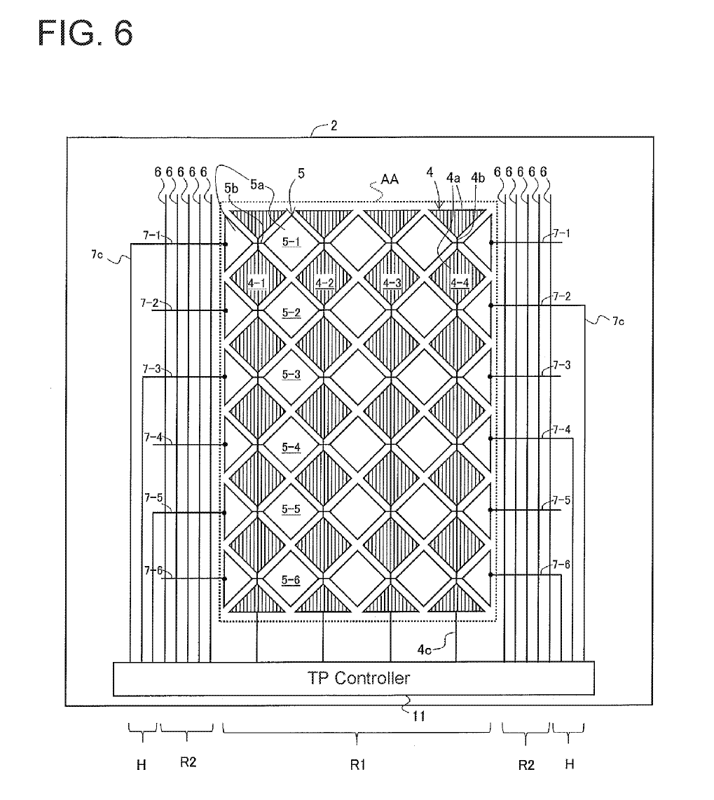

FIG. 6 is a plan view that shows one example of a configuration of a display device 10 of Embodiment 2. In the example shown in FIG. 6, the configuration of first electrodes 6 and second electrodes 5 & 7 differs from Embodiment 1. Specifically, the interval (pitch) between the first electrodes 4 in region R1 overlapping with the display area AA differs from the interval between the first electrodes 6 in region R2. In other words, the distance between the intersections of the first electrodes 4 and second electrodes 5 in region R1 differs from the distance between the intersections of the first electrodes 6 and second electrodes 7 in region R2. In the present example, the interval between the first electrodes 6 in region R2 is narrower than the interval between the first electrodes 4 in region R1. Therefore, the density of the first electrodes 4 and second electrodes 5 in region R2 is greater than the density of the first electrodes 6 and second electrodes 7 in region R1.

Differing the intervals of the electrodes in region R1 overlapping the display area AA from region R2 on the periphery thereof in this manner makes it possible to differ the detection precision of the touch panel in region R1 from the detection precision of the touch panel in region R2. In region R2, where the pitch of first wiring lines is narrow, it is possible to detect the contact or approaching of an object at a higher precision than in region R1, for example.

Furthermore, the shape of the first electrodes 4 in region R1 differs from the shape of the first electrodes 6 in region R2. Furthermore, the shape of the second electrodes 5 in region R1 also differs from the shape of the second electrodes 7 in region R2. Specifically, the first electrodes 4 and second electrodes 5 in region R1 include a plurality of square electrode pads connected to one another and aligned in the vertical or horizontal direction. In contrast, the first electrodes 6 in region R2 are linear electrodes that extend in the vertical direction, and the second electrodes 7 in region R2 are linear electrodes that extend in the horizontal direction. The first electrodes 6 and second electrodes 7 are separated by an insulating layer.

The second electrodes 5 of region R1 are not connected to the second electrodes 7 of region R2. In other words, the second electrodes 5 of region R1 extend to outside region R1 and form electrodes 7 in region R2. This makes it possible to efficiently arrange the electrodes of the touch panel in region R1 and in region R2, which is outside region R1. In the present example, the second electrodes 5 and 7 are driving electrodes that receive driving signals. In such a case, the driving electrodes in region R1 and the driving electrodes in region R2 can be controlled with the same driving signals. This makes it possible to simplify the control process. In the present example, all of the second electrodes 5 in region R1 are respectively connected to the second electrodes 7 in region R2; however, alternatively, a portion of the plurality of second electrodes 5 in region R1 may be connected to the second electrodes 7 in region R2.

In the example shown in FIG. 6, the interval between the first electrodes 4 in region R1 differs from the interval between the first electrodes 6 in region R2, and the interval between the second electrodes 5 in region R1 is the same as the interval between the second electrodes 7 in region R2. As a modification example, the interval between the second electrodes 5 in region R1 may be made different from the interval between the second electrodes 7 in region R2, and the interval between the first electrodes 4 in region R1 may be made different from the interval between the first electrodes 6 in region R2. Alternatively, the interval between the first electrodes 4 in region R1 may differ from the interval between the first electrodes 6 in region R2, and the interval between the second electrodes 5 in region R1 may differ from the interval between the second electrodes 7 in region R2 (see Embodiment 3 for a specific example).

In the example shown in FIG. 6, the first electrodes 6 and second electrodes 7 in region R2 are linear (a so-called “line pattern”), but alternatively these may be formed as square electrode pads (e.g., diamond pattern electrode pads) that are connected to one another and aligned in a single direction, in a similar manner to the first electrodes 4 and second electrodes 5 in region R1. Furthermore, the shape of the first electrodes or second electrodes may be the same between region R1 and region R2 while having differing intervals.

Moreover, in the present embodiment, the interval between the first electrodes 4 in region R1 is different from the interval between the first electrodes 6 in region R2, but it is possible for the interval between the first electrodes 4 in region R1 to be the same as the interval between the first electrodes 6 in region R2 while having the shape of the first electrodes 4 in region R1 differ from the shape of the first electrodes 6 in region R2, for example.

In the present embodiment, the material of the first electrodes 4 and second electrodes 5 in region R1 can be made the same as the material of the first electrodes 6 and second electrodes 7 in region R2. The first electrodes 4 and 6 & second electrodes 5 and 7 of region R1 and region R2 can be transparent electrodes such as ITO, for example. In contrast, the material of the first electrodes 4 and second electrodes 5 in region R1 alternatively may differ from the material of the first electrodes 6 and second electrodes 7 in region R2. This allows for the difference in detection performance between region R1 and region R2 to be made even more marked. In addition, the lead-out direction of the lead-out wiring lines 5c in region R1 may differ from the lead-out direction of the lead-out wiring lines 7c in region R2. Moreover, the TP controller 11 to which the first electrodes 4 and second electrodes 5 in region R1 are connected may differ from the TP controller 11 to which the first electrodes 6 and second electrodes 7 in region R2 are connected.

(Operation Example)

In the example shown in FIG. 6, the second electrodes 5 and 7, which are driving electrodes, are connected in region R1 and region R2. In other words, the driving electrodes are shared between region R1, which corresponds to the display area AA, and region R2, which corresponds to the edge area. Therefore, a driving signal applied to a single second electrode can control the electric field of region R1 and region R2.

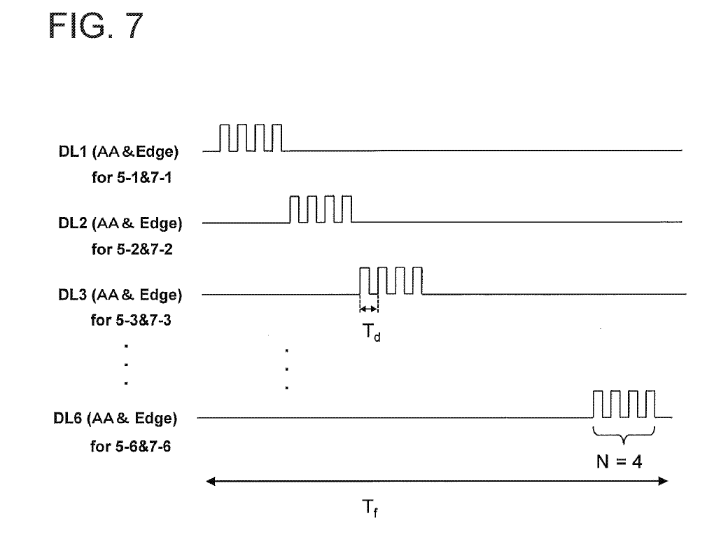

FIG. 7 shows one example of waveforms of driving signals applied to the second electrodes 5 and 7 in the touch panel 2 of FIG. 6. In FIG. 7, DL1 (AA & Edge), DL2 (AA & Edge), DL3 (AA & Edge), . . . , DL 6 (AA & Edge) represent the waveforms of driving signals respectively applied to second electrodes 5-1 & 7-1, 5-2 & 7-2, 5-3 & 7-3, . . . , 5-6 & 7-6, which straddle both region R2 and region R1 overlapping the display area. In the example shown in FIG. 7, a pulse is applied sequentially at period Td for a pre-determined amount of times or N times (in the present example, N=4) to each of the second electrodes 5-1 & 7-1, 5-2 & 7-2, 5-3 & 7-3, . . . , 5-6 & 7-6 formed in region R1 and region R2.

In this manner, common driving signals are applied to region R1 and region R2. In this example, the interval between the first electrodes 6 in region R2 may be smaller than the interval between the first electrodes 4 in region R1. Therefore, in region R2, the resolution of the touch panel in the horizontal direction, or namely, the direction in which the first electrodes 4 and 6 are aligned, is greater than region R1.

### Embodiment 3

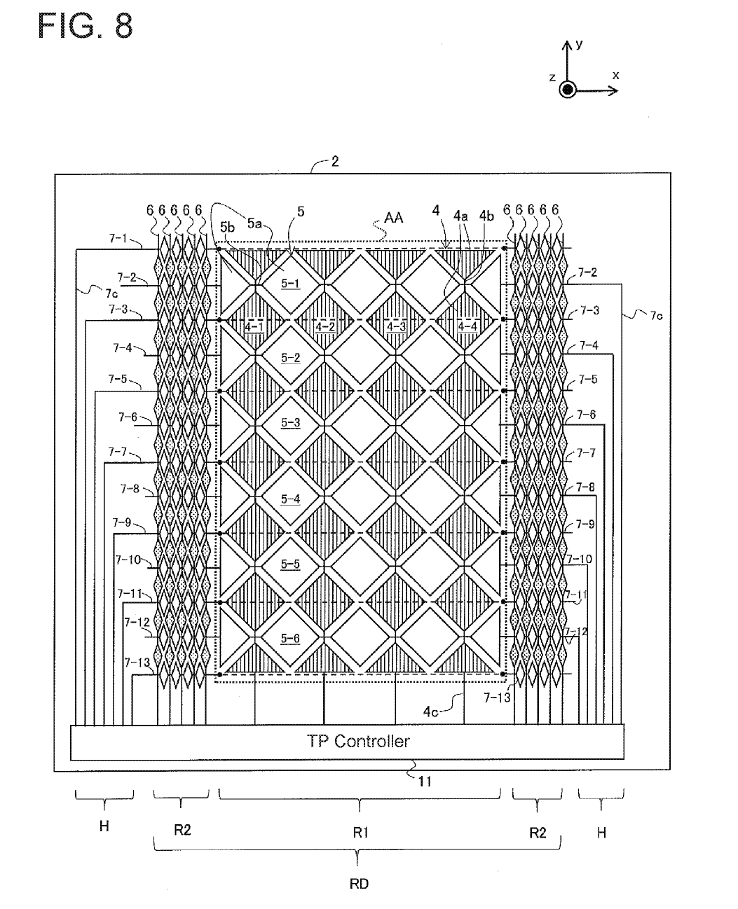

FIG. 8 is a plan view that shows one example of a configuration of a display device 10 of Embodiment 3. In the example shown in FIG. 8, the configuration of first electrodes 6 and second electrodes 5 & 7 differs from Embodiment 1 and Embodiment 2. Specifically, the interval between the first electrodes 4 in region R1 is different from the interval between the first electrodes 6 in region R2, and the interval between the second electrodes 5 in region R1 is different from the interval between the second electrodes 7 in region R2. In the present example, the interval between the first electrodes 6 in region R2 is narrower than the interval between the first electrodes 4 in region R1, and the interval between the second electrodes 7 in region R2 is narrower than the interval between the second electrodes 5 in region R1. Therefore, the density of the electrodes in region R2 is greater than the density of the electrodes in region R1. For example, the interval between both the first electrodes and second electrodes may differ from region R1 to region R2, thereby further distinguishing the detection characteristics between region R1 and region R2.

In the example shown in FIG. 8, the second electrodes 5-1 to 5-6 in region R1 respectively extend outside from the left and right sides of region R1 to connect to the second electrodes 7-2, 7-4, 7-6, 7-8, 7-10, and 7-12 in region R2. In region R2, second electrodes 7-1, 7-3, 7-5, 7-7, 7-9, 7-11, and 7-13 are respectively arranged in locations adjacent to the plurality of second electrodes 7-2, 7-4, 7-6, 7-8, 7-10, and 7-12 connected to the second electrodes 5-1 to 5-6 in region R1. In region R2, at least one second electrode 7 connected to the second electrodes 5 in region R1 is arranged between the second electrodes 7 not connected to the second electrodes 5 in region R1. In this manner, in the example shown in FIG. 8, the second electrodes include electrodes that are specialized for region R2 and electrodes that are shared between region R1 and region R2. In the present example, region R1 corresponds to the display area AA, and region R2 corresponds to the edge area.

In the example shown in FIG. 8, in both region R1 and region R2, the first electrodes 4 and 6 each include a plurality of square electrode pads arranged in a single direction. Specifically, the first electrodes 4 and 6 include a plurality of second electrodes aligned in the y direction (vertical direction) and connected to one another, and the second electrodes 5 and 7 include a plurality of electrode pads aligned in the x direction (horizontal direction) and connected to one another. The size of the electrode pads of the first electrodes 4 and second electrodes 5 in region R1 differs from the size of the electrode pads of the first electrode 6 and second electrodes 7 in region R2. Therefore, the interval between the first electrodes 4 in region R1 differs from the interval between the first electrodes 6 in region R2, and the interval between the second electrodes 5 in region R1 differs from the interval between the second electrodes 7 in region R2.

Specifically, the size and pitch of the electrode pads of the first electrodes 6 and second electrodes 7 in region R2 is less than the size and pitch of the electrode pads of the first electrodes 4 and second electrodes 5 in region R1. Therefore, the density of the electrode pads of the first electrodes 6 and second electrodes 7 in region R2 is greater than the density of the electrode pads of the first electrodes 4 and second electrodes 5 in region R1. This allows for the detection precision of region R2 to be made greater than that of region R1. For example, in region R2, it is possible to more finely detect the motion of an object than it is in region R1.

Among the second electrodes 7 in region R2, the second electrodes 7-2, 7-4, . . . , 7-12 connected to the second electrodes 5 in region R1 are connected to the TP controller 11 via lead-out wiring lines 7c that extend along a first side (the right side in FIG. 8) of the display area AA. Among the second electrodes 7 in region R2, the second electrodes 7-1, 7-3, . . . , 7-13 not connected to the second electrodes 5 in region R1 are connected to the TP controller 11 via the lead-out wiring lines 7c that extend along a second side (left side in FIG. 8) opposing the first side of the display area AA.

The second electrodes 7-1, 7-3, . . . , 7-13 in region R2 aligned along the first side (left side in the example shown in FIG. 8) of the display area AA and not connected to the second electrodes 5 in region R1 are respectively connected to the second electrodes 7-1, 7-3, . . . , 7-13 in region R2 aligned along the side (right side in the present example) opposing the first side of the display area AA. The second electrodes disposed with the display area AA therebetween can be connected to one another by wiring lines in a layer that is separated by an insulating film from the layer where the first electrodes 4 and second electrodes 5 of region R1 are arranged.

The material of the first electrodes 4 and second electrodes 5 (e.g., ITO or the like) in region R1 may be the same as the material of the first electrodes 6 and second electrodes 7 in region R2.

### Modification Example

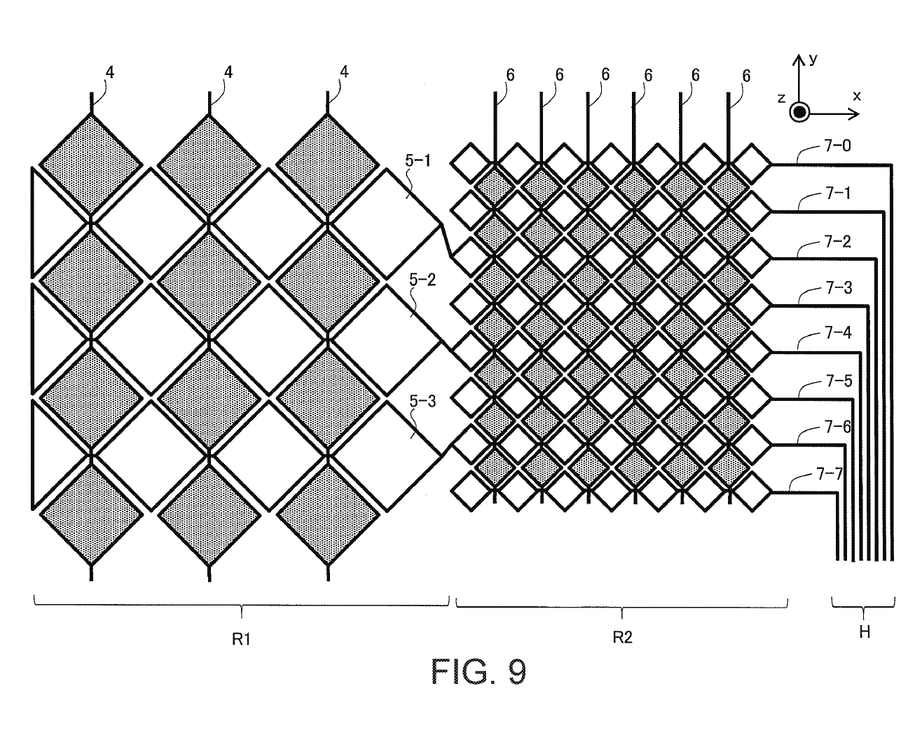

FIG. 9 shows a modification example of first electrodes and second electrodes, the respective intervals of which differ from region R1 to region R2. FIG. 9 is an electrode configuration example of a portion of region R1, region R2, and a wiring line area H. In the example shown in FIG. 9, the shape of the electrode pads of the first electrodes 4 and second electrodes 5 in region R1 is similar to the shape of the electrode pads of the first electrodes 6 and second electrodes 7 in region R2, but the size is different.

(Operation Example)

In the example shown in FIG. 8 and FIG. 9, a portion of the second electrodes 7-1 to 7-13 (7-2, 7-4, . . . , 7-12) in region R2, which are driving electrodes, is connected to the second electrodes 5-1 to 5-6 in region R1. In other words, a portion of the driving electrodes are shared between region R1 and region R2.

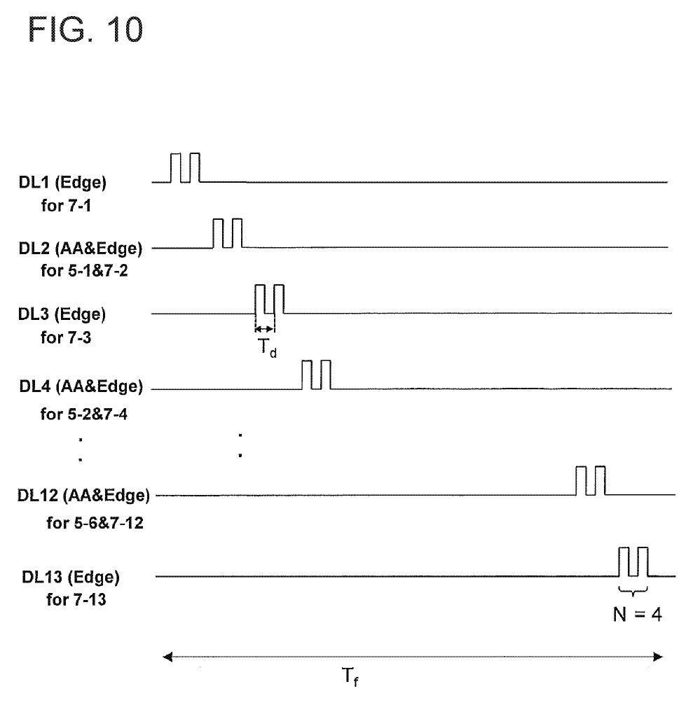

FIG. 10 shows one example of waveforms of driving signals applied to the second electrodes 5 and 7 of the touch panel 2 in FIG. 8. In FIG. 10, DL1 (Edge), DL3 (Edge), . . . , DL13 (Edge) represent waveforms of driving signals respectively applied to the second electrodes 7-1, 7-3, . . . , 7-13 in region R2, or namely, the driving electrodes specialized for the edge area. DL2 (AA & Edge), DL4 (AA & Edge), . . . , DL12 (AA & Edge) represent waveforms of driving signals respectively applied to the second electrodes 5-1 & 7-2, 5-2 & 7-4, . . . , 5-6 & 7-12 straddling both region R1 and region R2, or namely, the driving electrodes shared between region R1 and region R2.

In the example shown in FIG. 10, at period Td, pulses are sequentially applied at a pre-determined number of times or N times each (N=2 in the present example) to the second electrodes 7-1, 5-1 & 7-1, 7-3, 5-2 & 7-2, 5-3 & 7-3, . . . , 5-6 & 7-6, and 7-13. In this example, the interval between the first electrodes 6 in region R2 is less than the interval between the first electrodes 4 in region R1, and the interval between the second electrodes 7 in region R2 is less than the interval between the second electrodes 5 in region R1. Therefore, in region R2, the resolution of the touch panel in both the horizontal direction and vertical direction, or namely, the direction in which the first electrodes 6 are aligned and the direction in which the second electrodes 7 are aligned, is greater than in region R1.

The configuration of the first and second electrodes is not limited to the examples described above. For example, in the configurations described above, at least one among the material of the first electrodes 4 and 6 or second electrodes 5 and 7, the lead-out direction of the lead-out wiring lines 4c, 6, and 7c, or the connection point to the TP controller 11 of the first electrodes 4 and 6 & second electrodes 5 and 7 may be made to differ between region R1 and region R2.

### Embodiment 4

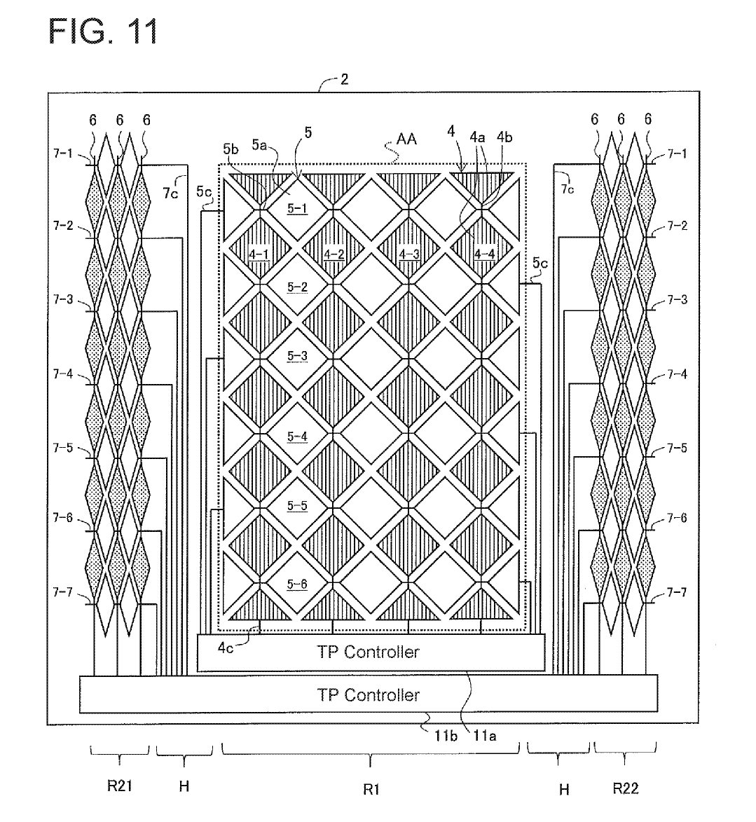

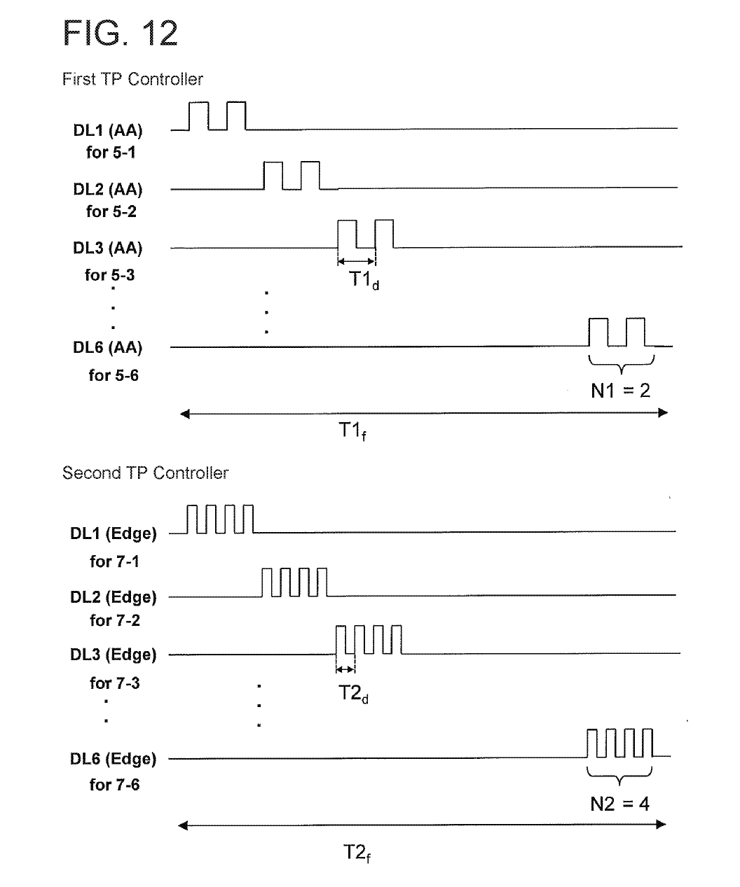

FIG. 11 is a plan view that shows one example of a configuration of a display device 10 of Embodiment 4. In the example shown in FIG. 11, the configuration of the first electrodes 4 and 6 & second electrodes 5 and 7, and the configuration of the TP controller, differ from Embodiments 1 to 3. In the example shown in FIG. 11, the arrangement location of the lead-out wiring lines 5c of the second electrodes 5 in region R1 differs from the arrangement location of the lead-out wiring lines 7c of the second electrodes 7 in region R2. In the present embodiment, region R2 is a general term that encompasses region R21 and region R22 shown in FIG. 11.

Specifically, the second electrodes 5 in region R1 are connected to a first TP controller 11a located under region R1 via the lead-out wiring lines 5c arranged to the left and right of where the second electrodes 5 are formed. In contrast, in region R21 to the left of region R1, the connection to a second TP controller 11b is via the lead-out wiring lines 7c arranged to the right of the area where the second electrodes 7 are formed in region R21. In region R22 to the right of region R1, the connection to the second TP controller 11b is via the lead-out wiring lines 7c arranged to the left of the area where the second electrodes 7 are formed in region R22. In other words, in the example shown in FIG. 11, the lead-out wiring lines 5c in region R1 are led out from second wiring lines 5 in a direction from the inside of the touch panel 2 to the outside. The lead-out wiring lines 7c of region R21 and region R22 are led out from second wiring lines 7 in a direction from the inside of the touch panel 2 to the outside. The lead-out direction of the lead-out wiring lines from the second electrodes differs between region R1 and region R2.

In this manner, by differing the arrangement location of the lead-out wiring lines between region R1 and region R2, it becomes easy to arrange electrodes in order to achieve detection performance that is respectively suitable for region R1 and region R2. In the example in FIG. 11, in region R2, the first electrodes 6 and second electrodes 7 are arranged in a location along the left and right ends of the touch panel 2, and the lead-out wiring lines 7c of the second electrodes 7 are arranged on the inside of this area, for example. In other words, the lead-out wiring lines 5c and 7c that connect the second electrodes 5 and 7 and the TP controllers 11 and 11b are arranged between region R1 and region R2. This makes it possible to further enhance detection performance for objects at the edges of the display device 10, due to the first electrodes 6 and second electrodes 7 being disposed in locations near the edges of the touch panel 2.

Furthermore, the TP controller 11a to which the first electrodes 4 and second electrodes 5 in region R1 are connected differs from the TP controller 11b to which the first electrodes 6 and second electrodes 7 in region R2 are connected. In other words, both the first TP controller 11a and the second TP controller 11b are provided, with the first TP controller 11a controlling signals of the first electrodes 4 and second electrodes 5 in region R1 so as to detect objects in region R1, and the second TP controller 11b controlling signals of the first electrodes 6 and second electrodes 7 in region R2 so as to detect objects in region R2. The first TP controller 11a and the second TP controller 11b can each be made of separate semiconductor chips, for example. Alternatively, it is possible to implement a system whereby the first TP controller 11a and the second TP controller 11b are made of the same semiconductor chip, but each can be independently driven.

In this manner, by independently providing the first TP controller 11a that controls driving signals for the electrodes in region R1, and the second TP controller 11b that controls driving signals for the electrodes in region R2, it becomes easy to implement driving that corresponds to the individual detection characteristics of region R1 and region R2.

FIG. 12 shows one example of waveforms of driving signals applied to the second electrodes 5 and 7 in the touch panel 2 of FIG. 11. In FIG. 12, DL1 (AA), DL2 (AA), DL3 (AA), . . . , DL6 (AA) at the top represent waveforms of driving signals respectively applied from the first TP controller 11a to the second electrodes 5-1, 5-2, 5-3, . . . , 5-6 in region R1. DL1 (Edge), DL2 (Edge), DL3 (Edge), . . . , DL6 (Edge) at the bottom represent waveforms of driving signals respectively applied from the second TP controller 11b to the second electrodes 7-1, 7-2, 7-3, . . . , 7-6 in region R2.

In the example shown in FIG. 12, in region R1, at period T1d pulses are sequentially applied from the first TP controller 11a at a pre-determined number of times or N1 times each (N1=2 in the present example) to the second electrodes 5-1, 5-2, 5-3, . . . , 5-6, which are the driving electrodes.

In region R2, at period T2d pulses are sequentially applied from the second TP controller 11b at a pre-determined number of times or N2 times each (N1=4 in the present example) to the second electrodes 7-1, 7-2, 7-3, . . . , 7-6, which are the driving electrodes. In other words, the number of driving signal pulses or integral amount N2 applied to the driving electrodes in region R2 differs from the integral amount N1 in region R1. The period T2d of the driving signal pulses in region R2 also differs from the period T1d of the driving signal pulses in region R1. In the present example, an operating time T1f equivalent to one frame in region R1 is the same as an operating time T2f equivalent to one frame in region R2.

In the present embodiment, the first TP controller 11a controls the driving signals of region R1. The second TP controller 11b controls the driving signals of region R2. Differentiating the control systems between region R1 and region R2 in this manner makes it easy to control pulse periods, the integral amount, and the like, thus achieving the desired detection characteristics for each region.

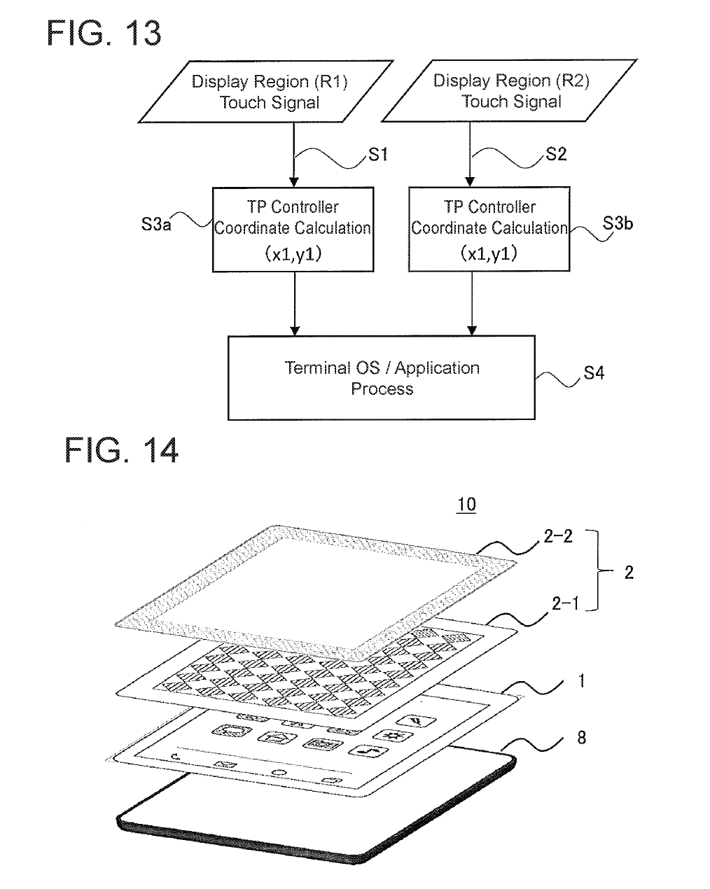

FIG. 13 shows an example of the total process flow of the display device 10, which includes the touch panel 2 in FIG. 11. In the example shown in FIG. 13, the touch signal for detecting the contact or approaching of an object to the display area AA is transmitted to the first TP controller 11a via the first electrodes 4 in region R1 of the touch panel 2 (S1). Furthermore, the touch signal for detecting the contact or approaching of an object to the edge area outside the display area AA is transmitted to the second TP controller 11b via the first electrodes 6 in region R2 (S2).

The first TP controller 11a calculates touch input data (e.g., coordinates x1,y1) for the display area AA in accordance with the touch signal from region R1 (S3a). The second TP controller 11b calculates touch input data (e.g., coordinates x2,y2) for the edge area around the display area AA in accordance with the touch signal from region R2 (S3b).

The first TP controller 11a and the second TP controller 11b output touch input data to a computer in the display device 10, for example. The touch input data output from the first TP controller 11a and second TP controller 11b is used in processes by a terminal OS or application run by the computer in the display device 10 (S4).

Furthermore, as an example, the first TP controller 11a or second TP controller 11b may calculate hover height or the like with respect to the edge. Alternatively, the computer in the display device 10 can also use the touch input data output from the first and second TP controller 11a and 11b to calculate hover height or the like.

The configuration of the first and second electrodes is not limited to the examples described above. For example, in the configurations described above, the material of the first electrodes 4 and 6 or the second electrodes 5 and 7 may either be the same or different between region R1 and region R2. Furthermore, in the example described above, the interval between the first electrodes 4 in region R1 differs from the interval between the first electrodes 6 in region R2. In contrast, the interval and shape of the first electrodes 4 and second electrodes 5 in region R1 may be the same as the interval and shape of the first electrodes 6 and second electrodes 7 in region R2. Alternatively, the TP controller to which the first electrodes 4 and second electrodes 5 in region R1 are connected may be the same as the TP controller to which the first electrodes 6 and second electrodes 7 in region R2 are connected.

### Embodiment 5

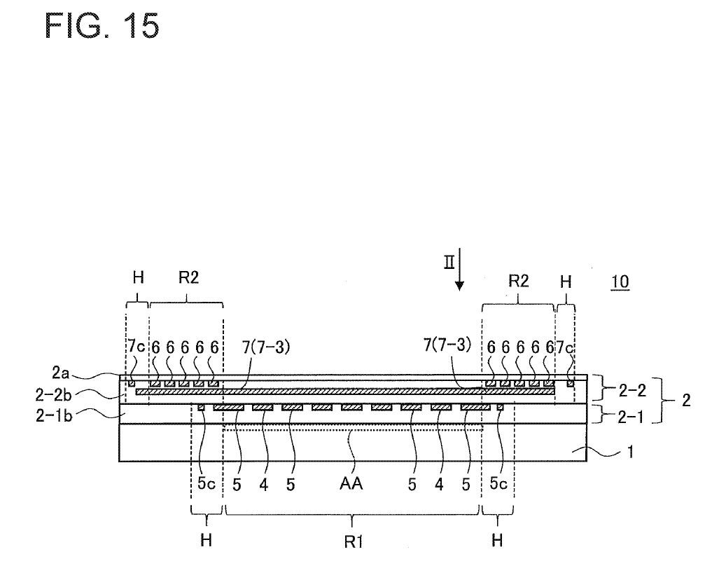

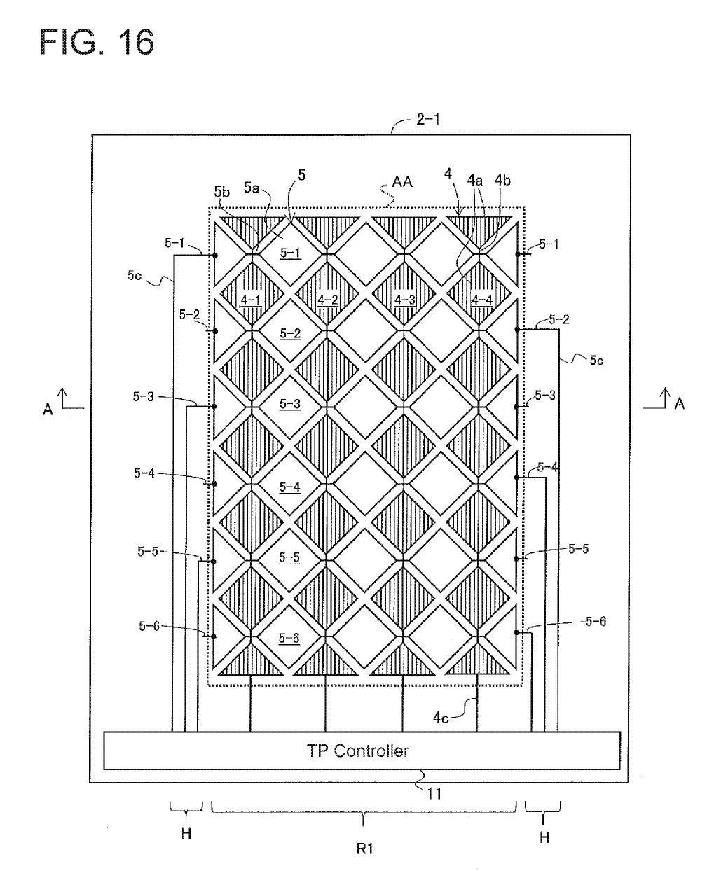

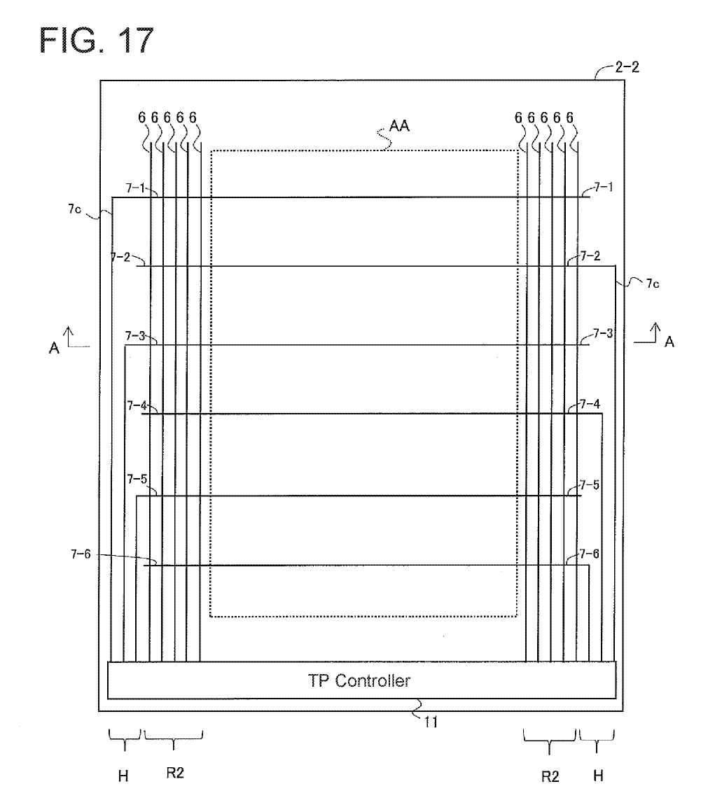

FIG. 14 shows one example of a layer configuration of a display device in Embodiment 5. FIG. 15 is a cross-sectional view of the display device 10 shown in FIG. 14. FIG. 16 shows an electrode configuration example of a first layer 2-1 in the touch panel 2 shown in FIG. 14 and FIG. 15. FIG. 17 shows an electrode configuration example of a second layer 2-2 in the touch panel 2 shown in FIG. 14 and FIG. 15. FIG. 15 is a cross-sectional view of FIG. 16 and FIG. 17 along the line A-A.

In the display device 10 shown in FIG. 14, the display panel 1 and the touch panel 2 are arranged in the frame 8 overlapping each other. The touch panel 2 includes the first layer 2-1 and the second layer 2-2. As shown in FIG. 15, the first layer 2-1 includes a transparent substrate 2-1b and first electrodes 4 & second electrodes 5 in region R1 provided on the transparent substrate 2-1b. The first layer 2-2 includes a transparent substrate 2-2b and first electrodes 6 & second electrodes 7 in region R2 provided on the transparent substrate 2-2b. In other words, the first electrodes 4 & second electrodes 5 in region R1 and the first electrodes 6 & second electrodes 7 in region R2 are formed in differing layers with the transparent substrate 2-1b, which is one example of an insulating layer, interposed therebetween.

As shown in FIG. 16, in the first layer 2-1, the first electrodes 4 and second electrodes 5 are arranged in region R1, which overlaps the display area AA. The first electrodes 4 are led out by lead-out wiring lines 4c from the bottom side of region R1 so as to connect to the TP controller 11. The second electrodes 5 are led out by lead-out wiring lines 45 from the left side and right side of region R1 so as to connect to the TP controller 11.

As shown in FIG. 17, in the second layer 2-2, the first electrodes 6 and second electrodes 7 are arranged in region R2 outside of region R1, i.e., in the edge area. The first electrodes 6 are linear electrodes that extend in the vertical direction, and the second electrodes 7 in region R2 are linear electrodes that extend in the horizontal direction. The first electrodes 6 and second electrodes 7 are separated by an insulating layer.

As shown in FIG. 16 and FIG. 17, forming the first electrodes 4 and second electrodes 5 in region R1 in a different layer from the first electrodes 6 and second electrodes 7 in region R2 facilitates a design that conforms to the individual detection performance desired for region R1 overlapping the display area AA and region R2 outside of region R1.

In the example shown in FIG. 17, the first electrodes 6 and second electrodes 7 in region R2 are linear, but these electrodes may be square electrode pads connected to one another and aligned in a single direction, in a similar manner to the first electrodes 4 and second electrodes 5 in region R1, for example. In this case, the first electrodes 6 and second electrodes 7 can be provided on the same surface on the transparent substrate 2-2b.

The interval and shape of the first electrodes 4 and second electrodes 5 in region R1 shown in FIG. 16 differ from the interval and shape of the first electrodes 6 and second electrodes 7 in region R2 shown in FIG. 17. In contrast, the interval or shape of the first electrodes 4 and second electrodes 5 in region R1 may be the same as the interval or shape of the first electrodes 6 and second electrodes 7 in region R2.

Furthermore, in the examples shown in FIG. 16 and FIG. 17, the first electrodes 4 and second electrodes 5 in region R1, and the first electrodes 6 and second electrodes 7 in region R2, are both connected to the same TP controller 11. In contrast, the first TP controller to which the first electrodes 4 and second electrodes 5 in region R1 are connected may be provided independently of the second TP controller to which the first electrodes 6 and second electrodes 7 in region R2 are connected.

The touch panel 2 of Embodiment 5 can be operated by using similar driving signals to the driving signals shown in FIG. 3 or FIG. 12, but the driving signals have no specific limitations, for example. The configuration of the first electrodes 6 and second electrodes 7 in region R2 are not limited to the examples described above, and Embodiments 1 to 4 above and Embodiment 7 below or the modification examples thereof can be applied.

### Embodiment 6

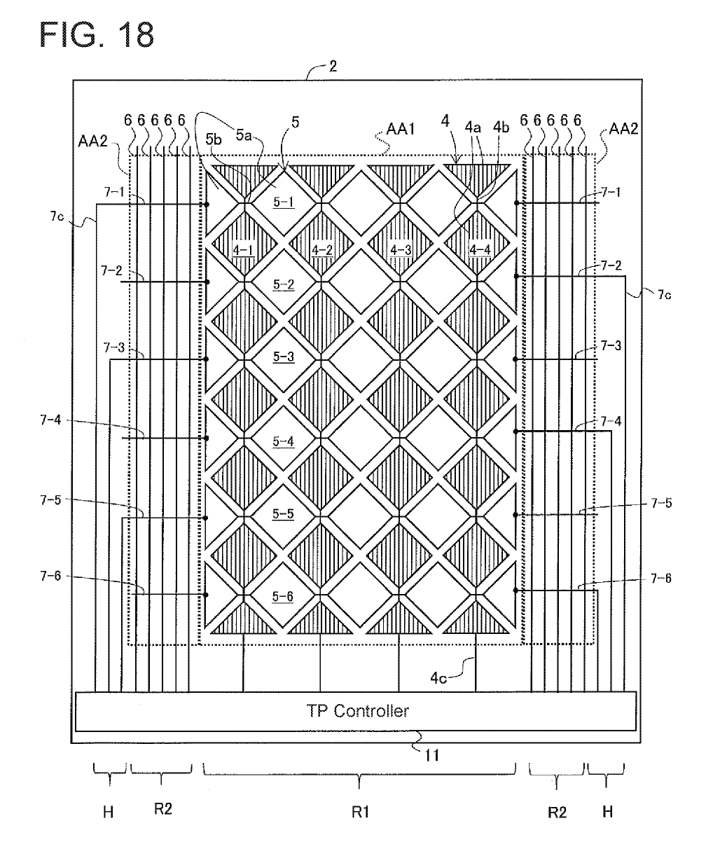

In Embodiments 1 to 5, region R2 does not overlap with the display area AA, but an arrangement is possible in which at least a portion of region R2 overlaps with the display area AA. FIG. 18 is a plan view that shows one example of a configuration of a display device 10 of Embodiment 6. In the example shown in FIG. 18, region R2 is also arranged in a location overlapping a display area AA2 of the display panel 1. The display panel 1 includes a first display area AA1 that corresponds to region R1 of the touch panel 2, and the second display area AA2 that corresponds to region R2 of the touch panel 2. The first electrodes 4 and second electrodes 5 in region R1 are provided in a region that overlaps the first display area AA1. The first electrodes 6 and second electrodes 7 in region R2 are provided in a region that overlaps the second display area AA2.

In the example shown in FIG. 18, the configuration of the first electrodes 4 and 6 & second electrodes 5 and 7 is similar to FIG. 6 but not limited thereto. For example, the first electrodes 4 and 6 & second electrodes 5 and 7 can also be configured similar to FIG. 2, FIG. 8, FIG. 11, or FIG. 16 and FIG. 17, for example. Furthermore, a configuration is also possible in which at least one of the material of the electrodes for detecting objects, the interval between the electrodes, the shape of the electrodes, the TP controller to which the electrodes connect, or the arrangement location of the lead-out wiring lines connected to the electrodes, differ between region R1 and region R2. This makes it possible to have different detection performance between region R1 and region R2.

The first display area AA1 and second display area AA2 are respectively arranged in the region R1 and region R2 that differ in detection performances in the manner described. Respectively controlling the image displayed on the first display region AA1 and the image displayed on the second display region AA2 makes it possible to provide a user interface based on the detection performance in the first display area AA1 and second display area AA2.

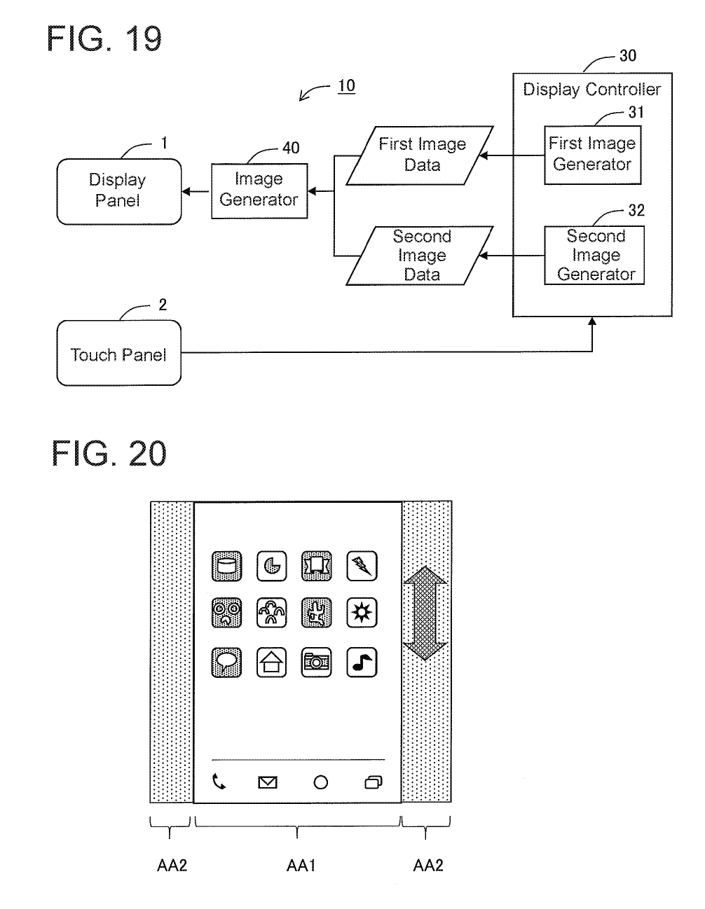

FIG. 19 is a functional block view showing a configuration example of the display device 10 of Embodiment 6. In the example shown in FIG. 19, the display device 10 includes the display panel 1, touch panel 2, image processor 40, and a display controller 30. The display controller 30 includes a first image generator 31 and a second image generator 32.

The display controller 30 obtains location information of an object from the touch panel 2, determines the image to be displayed based on the location information of the object, and then outputs image data to the display panel 1. In particular, the first image generator 31 generates an image to be displayed on the first display region AA1 in accordance with the location of the object detected in region R1 of the touch panel 2. The second image generator 32 generates an image to be displayed on the second display region AA2 in accordance with the location of the object detected in region R2.

The first image generator 31 may alternatively generate an image in accordance with the location of an object detected in region R1, and not just region R2. Furthermore, the second image generator 32 may alternatively generate an image in accordance with the location of an object detected in region R2, and not just region R1.

The display controller 30 can be a processor specialized for image processing, a CPU, or a combination of these, for example. A portion or all of the processes by the display controller 30 may be executed in an OS run by a computer in the display device 10, for example.

The image processor 40 processes first image data and second image data and then outputs the result to the display panel 1. The display panel 1 displays an image on the first display area AA1 and second display area AA2 in accordance with the image data received from the image processor 40. The image processor 40 can transmit the image data constituted by combining the first image data and the second image data to the display panel 1. Alternatively, the image processor 40 may individually send the first image data and second image data to the display panel 1, and then a combining process may be performed in the display panel 1. Furthermore, alternatively, the display controller 30 may be the unit that transmits to the image processor 40 the image data constituted by combining the first image data and second image data, or namely, the image data constituted by combining the image to be displayed in the first display area AA1 and the image to be displayed in the second display area AA2,

FIG. 20 shows one example of images displayed on a first display area AA1 and a second display area AA2. In the example shown in FIG. 20, a GUI image provided by the OS is displayed in the first display area AA1. A GUI image unique to the display device 10 Is displayed in the second display area AA2. In this example, the first display area AA1 can assume the originally-intended main display of the display device 10, and the second display area AA2 can assume a sub-display for assisting the GUI in the main display. Examples of the sub-display include various types of helpful indicators such as battery level, signal strength, time, date, and weather, or display objects that accept user input such as an incoming mail button, shortcuts, touch pads, keyboard, dials, switches, or the like. This makes it possible to realize a user interface that is separate from the user interface provided by the display area AA1.

In area R1 corresponding to the first display area AA1, transparent electrodes made of ITO or the like can be used as the first electrodes 4 and second electrodes 5 of the touch panel 2, for example. In contrast, in region R2 corresponding to the second display area AA2, electrodes made of metal can be used as the first electrodes 6 and second electrodes 7. Moreover, the first electrodes 6 and second electrodes 7 can be arranged denser than in region R1. Due to this, it is possible that whereas the detection performance in region R2 can be made higher than that of region R1, the transmittance of region R2 may be lower than region R1. Even if the transmittance of the second display area AA2 were lowered, there would likely not be a large effect on display quality, because the second display area AA2 is the sub-display, rather than the main display. Thus, it is possible to maintain the originally-intended display quality while improving the detection performance of region R2.

The display controller of the present embodiment can be applied to Embodiments 1-6 described above, Embodiment 7 described below, or the modification examples of these.

### Embodiment 7

In Embodiments 1 to 6, region R2 is arranged to the left and right of region R1, which overlaps the display area AA. However, the arrangement of region R1 and region R2 is not limited to the examples described above. Region R2 can be arranged as necessary around region R1. For example, region R2 may be arranged above and below region R1, rather than to the left and right of region R1. Furthermore, region R2 can also be arranged both to the left and right and above and below region R1. Alternatively, region R2 can also be arranged along one side of the four sides of region R1.

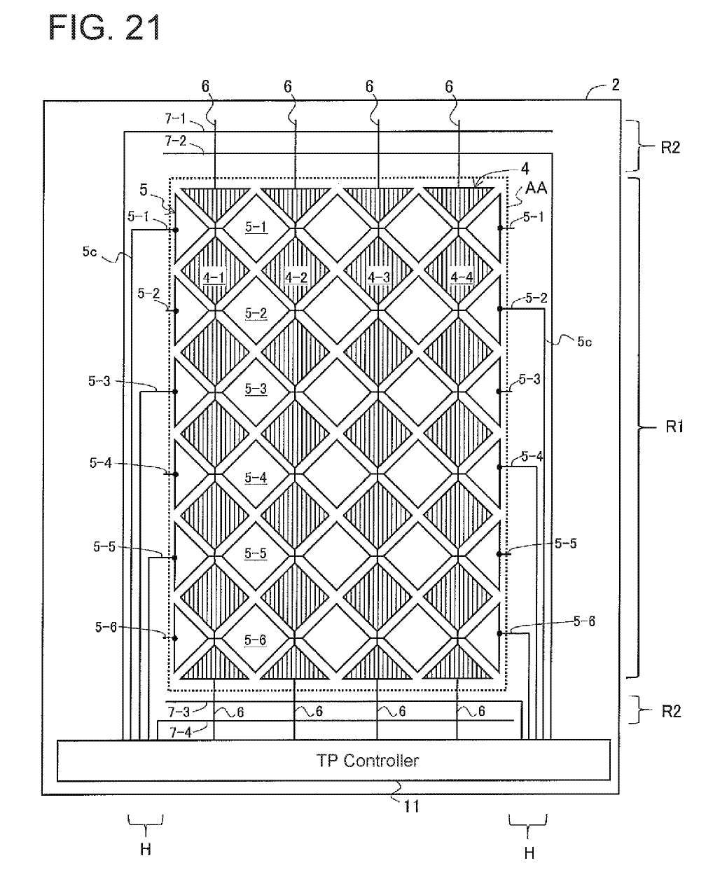

FIG. 21 shows an example of the placement of region R2 above and below region R1. In the example shown in FIG. 21, region R2 is arranged on an area along the top side and on an area along the bottom side of region R1. Specifically, the first electrodes 4 in region R1 extending in the vertical direction extend from the top side and bottom side of region R1 to the outside. The first electrodes extending to the outside of region R1 intersect in a plan view with the second electrodes 7 that extend in a horizontal direction in region R2. In other words, the first electrodes intersecting with the second electrodes 7-1 to 7-4 outside region R1 are the first electrodes 6 of region R2. In this example, the first electrodes 4 in region R1 are connected to the first electrodes 6 in region R2. In this manner, region R1 and region R2 can share the first electrodes.

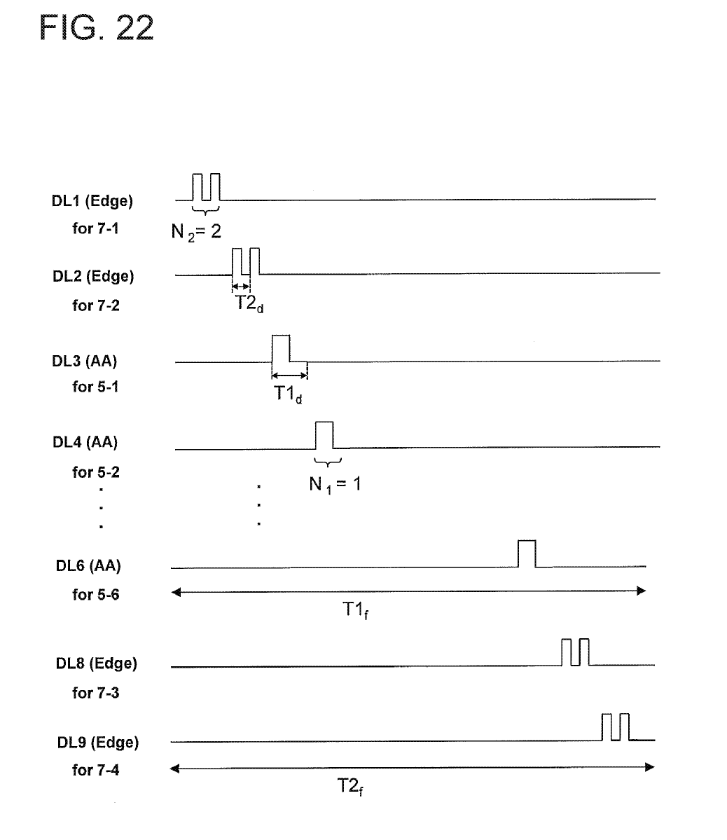

FIG. 22 shows one example of waveforms of driving signals applied to the second electrodes 5 and 7 in the touch panel 2 of FIG. 21. In FIG. 22, DL1 (Edge) and DL2 (Edge) represent waveforms of driving signals respectively applied to the second electrodes 7-1 and 7-2 in region R2 above region R1. DL3 (AA), DL4 (AA), . . . , DL6 (AA) represent waveforms of driving signals respectively applied to the second electrodes 5-1, 5-2, . . . , 5-6 in region R1. DL8 (Edge) and DL9 (Edge) represent waveforms of driving signals respectively applied to the second electrodes 7-3 and 7-4 in region R2 below region R1.

In the example shown in FIG. 22, at period T2d pulses are applied at a pre-determined number of times or N2 times each (N2=2 in the present example) to the second electrodes 7-1 and 7-2, which are driving electrodes in region R2 above region R1. Thereafter, at period T1d pulses are sequentially applied a pre-determined number of times or N1 times each (N1=1 in the present example) to the second electrodes 5-1 to 5-6, which are driving electrodes in region R2. Then, at period T2d pulses are sequentially applied N2 times each to the second electrodes 7-3 and 7-4 in region R2 below region R1.

The period T2d and number N2 of pulses of the driving signals applied to the driving electrodes in region R2 both differ from the period T1d and number N1 of pulses in region R1. An operating time T1f equivalent to one frame in region R1 is the same as an operating time T2f equivalent to one frame in region R2.

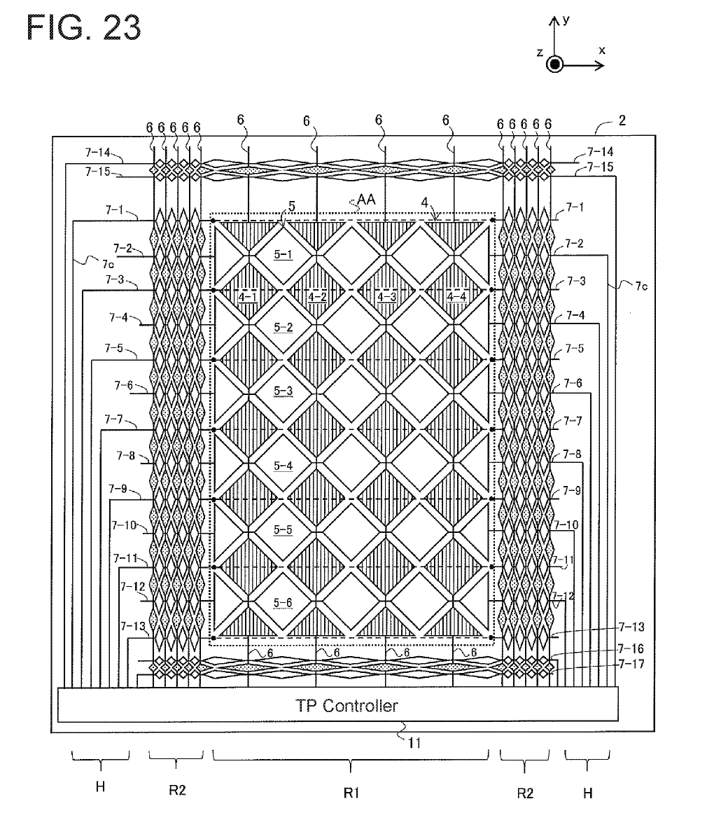

FIG. 23 shows an example of the placement of region R2 both to the left and right of and above and below region R1. In the example shown in FIG. 23, region R2 is arranged on an area along the left side, right side, top side, and bottom side of region R1. In other words, region R2 is arranged in an area surrounding region R1. In this example, region R1 exactly coincides in position with the display area AA, and thus region R2 surrounds the periphery of the display area AA. Specifically, the first electrodes 4 in region R1 extending in the vertical direction extend from the top side and bottom side of the display area AA to the outside. Moreover, the second electrodes 5 in region R1 extending in the left-right direction extend to outside from the left side and right side of region R1.

The first electrodes extended to outside from the top side of region R1 intersect in a plan view with the second electrodes 7-14 and 7-15 extending horizontally in region R2. The first electrodes extended to outside from the bottom side of region R1 intersect in a plan view with the second electrodes 7-16 and 7-17 extending horizontally in region R2. In this manner, the first electrodes intersecting the second electrodes 7-14 to 7-17 above and below region R1 are the first electrodes 6 of region R2. The second electrodes extended to outside from the left side and right side of region R1 intersect in a plan view with the first electrodes 6 extending in the vertical direction in region R2. In this manner, the second electrodes 7-1 to 7-13 intersecting the first electrodes 6 on the left and right of region R1 are the second electrodes of region R2.

In the example shown in FIG. 23, the first electrodes 4 in region R1 connect to a portion of the first electrodes 6 in region R2, and the second electrodes 5 in region R1 connect to a portion of the second electrodes 7 in region R2. In this manner, it is possible for the first electrodes and second electrodes to be shared by region R1 and region R2. In FIG. 23, the configuration of the first electrodes 4 and second electrodes 5 in region R1, and the second electrodes 7-1 to 7-13 in region R2 to the left and right of region R1, are the same as in FIG. 8. In other words, in region R2 to the left and right of region R1, at least one of the second electrodes 7 that is connected to the second electrodes 5 in region R1 is arranged between the second electrodes 7 that are not connected to the second electrodes 5 in region R1.

Furthermore, the first electrodes 6 in region R2 arranged to the left of region R1 (five of the first electrodes 6 in the example in FIG. 23) intersect with the second electrodes 7-14 and 7-15 arranged above region R1 and the second electrodes 7-16 and 7-17 arranged below region R1. In a similar manner, the first electrodes 6 in region R2 arranged to the right of region R1 (five of the first electrodes 6 in the example in FIG. 23) intersect with the second electrodes 7-14 and 7-15 arranged above region R1 and the second electrodes 7-16 and 7-17 arranged below region R1. In this manner, in region R2, making the electrodes arranged along two adjacent sides of region R1 intersect with one another allows objects to be detected around the corners between these two sides of region R1.

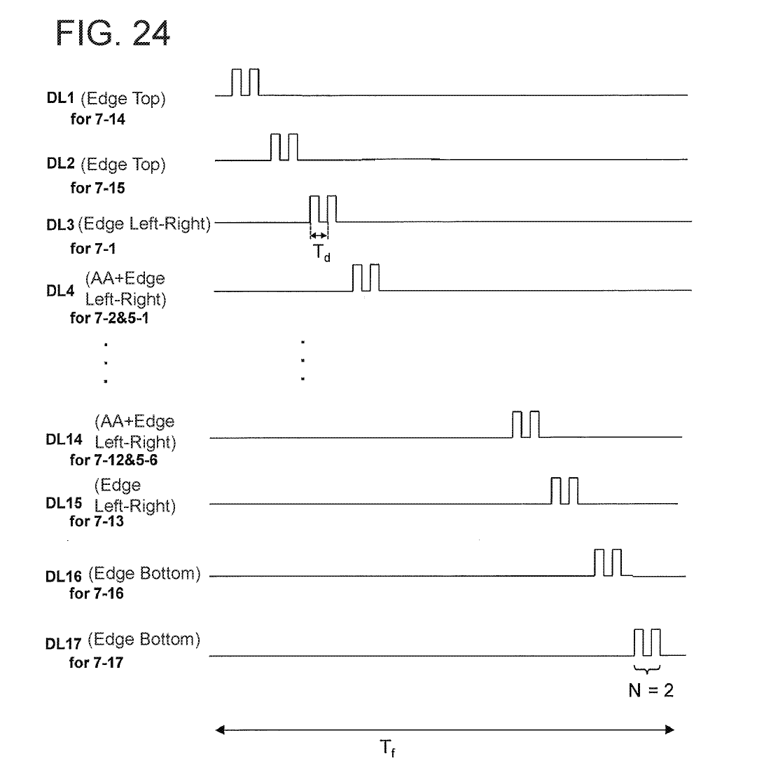

FIG. 24 shows one example of waveforms of driving signals applied to the second electrodes 5 and 7 in the touch panel 2 of FIG. 23. In FIG. 24, DL1 (Edge Top) and DL2 (Edge Top) represent waveforms of driving signals respectively applied to the second electrodes 7-14 and 7-15 in region R2 above region R1. DL3 (Edge Left-Right) represents waveforms of driving signals applied to the second electrodes 7-1 in region R2 to the left and right of region R1. DL4 (AA+Edge Left-Right) represents waveforms of driving signals applied to the second electrodes 5-1 in region R1 and to the second electrodes 7-2 in region R2 connected to both ends of the second electrodes 5-1, and DL14 (AA+Edge Left-Right) represents waveforms of driving signals applied to the second electrodes 5-6 in region R1 and to the second electrodes 7-12 in region R2 connected to the left and right of the second electrodes 5-6. DL15 (Edge Left-Right) represents waveforms of driving signals applied to the second electrodes 7-13 in region R2 arranged to the left and right of region R1, and DL16 (Edge Bottom) & DL17 (Edge Bottom) respectively represent waveforms of driving signals applied to the second electrodes 7-16 and 7-17 in region R2 below region R1.

In the example shown in FIG. 24, at period Td pulses are sequentially applied a pre-determined number of times or N times each (N=2 in the present example) to the second electrodes 7-14, 7-15, 7-1, 7-2 & 5-1, 7-3, 7-4 & 5-2, . . . , 7-12 & 5-6, 7-13, 7-16, and 7-17, which are driving electrodes.

In the example shown in FIG. 23, the interval between the driving electrodes and reception electrodes (first electrodes 6 and second electrodes 7-1 to 7-17) in region R2 is narrower than the interval between the driving electrodes and reception electrodes (first electrodes 4 and second electrodes 5) in region R1. Therefore, the touch resolution in the X direction and Y direction of the edge area surrounding the display area AA is improved more than the display area AA.

In the example shown in FIG. 24, the first electrodes 6 and second electrodes 7-1 to 7-17 in region R1 are diamond patterns including a plurality of square electrode pads, but at least a portion of the first electrodes 6 and second electrodes 7-1 to 7-17 can be formed in a linear shape.

### Embodiment 8

In the display device 10 in Embodiments 1 to 7 described above, the first electrodes 6 and second electrodes 7 in region R2 of the touch panel 2 make it possible to detect the contact or approach of an object on the edge of the transparent cover 2a.

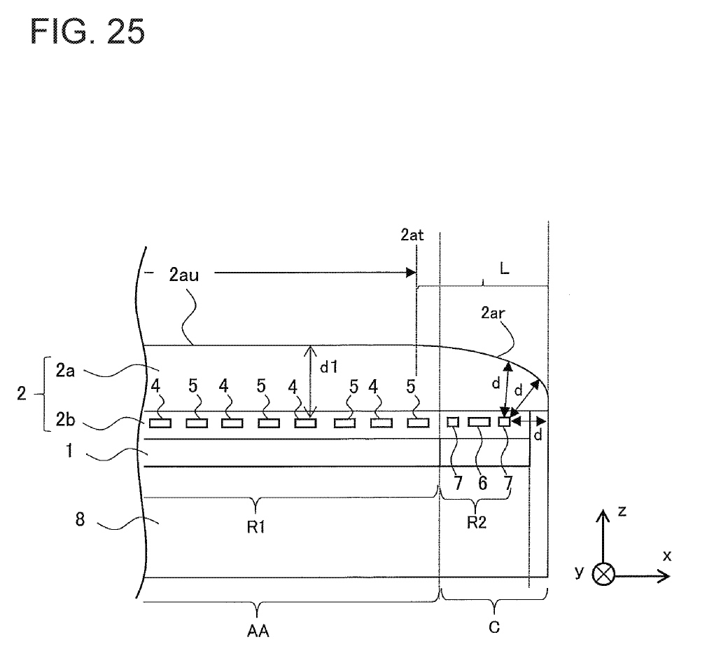

FIG. 25 is a cross-sectional view that shows one example of a configuration for detecting objects on the edge of a transparent cover 2a of a touch panel 2. In the example in FIG. 25, a display panel 1 having a display area AA and a touch panel 2 are stored in a frame 8 overlapping one another. The touch panel 2 includes a transparent substrate 2b, on which first electrodes 4 and 6 & second electrodes 5 and 7 are provided, and a transparent cover 2a, which covers the transparent substrate 2b.

The touch panel 2 includes region R1 overlapping the display area AA and the region R2 overlapping an edge area C. In addition to region R2, a lead-out wiring region for arranging lead-out wiring lines may also overlap the edge area C, for example.

In the example shown in FIG. 25, a side face (end face) 2ar connected to a top 2au of the transparent cover 2a has a curved surface. In this manner, processing the end face so as to be a curved surface makes it possible smooth the end of the transparent cover 2a, or namely, the edge of the portion where the top 2au and side face 2ar are connected. Furthermore, the edge of the end of the transparent cover 2a is exposed at the case. In this manner, at least a portion of the side face 2ar of the transparent cover 2a may be exposed, and the contact or approach of an object on this exposed portion may be detected by the touch panel 2. This makes it possible for the user to operate the display device 10 by touching or tracing the edge of the end of the transparent cover 2a.

Furthermore, curving the side face 2ar of the transparent cover 2a allows the transparent cover 2a to be a lens. The progression direction of light emitted from the display area AA of the display panel 1 is modified at the side face 2ar, for example. As shown in FIG. 25, at the side face 2ar of the transparent cover 2a, the thickness of the transparent cover 2a becomes progressively thinner further outside. In this manner, by differing the thickness of the transparent cover 2a, it is possible to differ the detection precision of the touch panel 2 or the detected capacitance values.

The distance d from the surface of the frame 8 or transparent cover 2a outside the display area AA, or namely the frame area C in FIG. 25, to the second electrodes 7 along the outer edge of the touch panel 2, can be set as the detectable distance of the touch panel 2. The detectable distance is the distance in which the existence of an object can be detected by the touch panel 2. This makes it possible to detect the contact or approach of an object to the surface of the display device 10 outside of the display area AA.

Furthermore, the distance d described above can be set to a distance dl or lower, which is a distance in a direction perpendicular to the display surface of the display panel 1 between the touch panel 2 (specifically, the first electrodes 4 and 6 & second electrodes 5 and 7) and the top 2au of the transparent cover 2a. This makes it possible to more reliably detect the contact or approach of an object to the surface of the display device 10 outside of the display area AA. The configuration of the frame 8 and transparent cover 2a is not limited to the example shown in FIG. 25.

The transparent cover 2a can have a lens L arranged so as to straddle the border of the display area AA and the edge area C outside the display area, for example. In the configuration shown in FIG. 25, the lens L can be formed by curving the surface of the side face 2ar, which is connected to the top 2au of the transparent cover 2a. In this example, the border between the display area AA and the edge area C outside of the display area extends in the y direction (the first direction). The lens L refracts a portion of the light emitted from the display area AA towards the edge area C, thereby obscuring the edge area C and enabling an image to be displayed until the edge of the case. Furthermore, by making the line of intersection between a plane perpendicular to the y direction and the viewing side surface of the lens L, or namely the side face 2ar, a non-arc curved line, the lens L can refract light so as to substantially equalize the pitch of the light emitted from the plurality of pixels in the display area AA in the plane perpendicular to the y direction, thereby enabling a reduction in distortion of the displayed images.

In the display device 10 having the configuration shown in FIG. 25, it is possible to detect objects at the edges of the transparent cover 2a, i.e., edge detection. By making the display device 10 shown in Embodiments 1 to 7 capable of edge detection, it is easy to realize a configuration that satisfies both the desired detection performance for edge detection and the desired detection performance for the display area AA.

### Application Examples

Various types of electronic devices that include the display device 10 described in Embodiments 1 to 8 above are included in the embodiments of the present invention. For example, the display device of the present invention can be applied to smartphones, mobile phones, tablet terminals, gaming systems, general-purpose computers, various types of remote controllers, digital cameras, video cameras, in-vehicle panels, car navigation devices, television devices, ATMs, electronic bulletin boards, electronic guideboards, electronic whiteboards, and the like. By installing the display device 10 of Embodiments 1 to 8 described above, these various types of electronic devices can have a touch panel with suitable detection performance that complements the usage of the electronic device.

Embodiments of the present invention were described above, but the embodiments of the present invention are not limited to Embodiments 1 to 8 described above. For example, the embodiments above describe sequential driving in which pulse signals are sequentially applied to a plurality of second electrodes 5 and 7, but it is also possible to perform parallel driving in which pulse signals are simultaneously applied to the plurality of second electrodes 5 and 7. Parallel driving can shorten the operating time more than sequential driving. Furthermore, the embodiments above describe operation of a touch panel that uses a mutual capacitance scheme, but the touch panel 2 may use a self-capacitance scheme instead.

In Embodiments 1 to 7 described above, region R1 and region R2 are planes that are parallel to each other. Specifically, the first electrodes and second electrodes in region R1 are either formed in the same layer as the first electrodes and second electrodes in region R2, or are respectively formed in two different layers that are parallel to each other. In other words, the first electrodes 4 & second electrodes 5 in region R1 and the first electrodes 6 & second electrodes 7 in region R2 are all formed in planes that are parallel to the display surface of the display area AA. In contrast, if region R1 and R2 are not arranged parallel to each other, then the first electrodes 6 and second electrodes 7 in region R2 can be arranged on the side face of the transparent cover 2a or transparent cover 2b, for example. If region R1 and region R2 are arranged parallel to each other, the manufacturing process is simpler than if the regions are not parallel to each other.

Furthermore, the display panel is not restricted to a liquid crystal panel. The display panel may be an organic EL display, a plasma display, a display that uses electrophoresis or MEMS, or the like, for example.

### DESCRIPTION OF REFERENCE CHARACTERS

1 display panel
2 touch panel
4 first electrodes in first region
5 second electrodes in first region
6 first electrodes in second region
7 second electrodes in second region
4c, 5c, 6c, 7c lead-out wiring lines
10 display device
11 TP controller
30 display controller
31 first image generator
32 second image generator

1. A display device, comprising:
a display panel including a display area that displays an image; and
a touch panel including a plurality of first electrodes and a plurality of second electrodes overlapping the display panel, said touch panel detecting contact or approach of an object by detecting capacitances among the first electrodes and second electrodes,
wherein the touch panel includes a first region overlapping the display area, and a second region outside the first region, and
wherein at least one of the following differs between the first region and the second region:
a material of the first electrodes and the second electrodes;
an interval between the first electrodes or between the second electrodes;
a shape of the first electrodes or the second electrodes;
a controller to which the first electrodes and the second electrodes are connected; and
a location at which lead-out wiring lines connected to the first electrodes or the second electrodes are disposed.

2. The display device according to claim 1, wherein the interval between the first electrodes or between the second electrodes in the second region is smaller than the interval between the first electrodes or between the second electrodes in the first region.

3. The display device according to claim 1,
wherein the touch panel includes a transparent cover covering the first electrodes and the second electrodes, and
wherein the touch panel detects contact or approach of the object at an edge of the transparent cover via the first electrodes and the second electrodes in the second region.

4. The display device according to claim 1,
wherein the first electrodes and the second electrodes in the first region are transparent conductors, and
wherein the first electrodes and the second electrodes in the second region are metal conductors.

5. The display device according to claim 1,
wherein the first electrodes and the second electrodes in the first region are formed in a layer different from a layer in which the first electrodes and the second electrodes in the second region are formed.

6. The display device according to claim 1, wherein a plane on which the first electrodes and the second electrodes in the first region are provided and a plane on which the first electrodes and the second electrodes in the second region are provided are both parallel to a display surface of the display panel.

7. The display device according to claim 1,
wherein the display panel includes a first display area corresponding to the first region of the touch panel, and a second display area corresponding to the second region of the touch panel,
wherein the display device further comprises: a first image generator that generates an image to be displayed in the first display area in accordance with a location of an object detected in the first region of the touch panel, and a second image generator that generates an image to be displayed in the second display area in accordance with a location of an object detected in the second region of the touch panel.

8. The display device according to claim 1, wherein at least a portion of the first electrodes or the second electrodes in the first region is connected to at least a portion of the first electrodes or the second electrodes in the second region.

9. (canceled)
